(19) United States
(12) Patent Application Publication
(10) Pub. No.: US 2026/0128015 A1
(43) Pub. Date: May 7, 2026

(54) PROCESSOR, DISPLAY DEVICE INCLUDING THE PROCESSOR, AND ELECTRONIC DEVICE INCLUDING THE PROCESSOR

(71) Applicant: Samsung Display Co., Ltd., Yongin-si (KR)

(72) Inventor: Sehyuk Park, Yongin-si (KR)

(21) Appl. No.: 19/320,549

(22) Filed: Sep. 5, 2025

(30) Foreign Application Priority Data
Nov. 4, 2024 (KR) 10-2024-0154710

(51) Int. Cl. G09G 3/3291; G09G 3/3233

(52) U.S. Cl. CPC G09G 3/3291; G09G 3/3233; G09G 2300/0452; G09G 2300/0852; G09G 2300/0861; G09G 2320/0276; G09G 2330/021

(57) ABSTRACT

A display device includes a pixel unit including pixels connected to data lines, gate lines, and light-emission control lines, a data driver which outputs a data voltage through output lines, a data distribution circuit which connects each of the output lines to an odd-numbered data line during a first sub-frame period and connects each of the output lines to an even-numbered data line during a second sub-frame period, a first gate driver which sequentially outputs a first gate signal to each of first gate lines during the first sub-frame period, a second gate driver which sequentially outputs a second gate signal to each of second gate lines during the second sub-frame period, and a light-emission control driver which divides the light-emission control lines into groups of four and output light-emission control signals in units of groups.

This application claims priority to Korean Patent Application No. 10-2024-0154710, filed on Nov. 4, 2024, and all the benefits accruing therefrom under 35 U.S.C. § 119, the content of which in its entirety is herein incorporated by reference.

### BACKGROUND

### 1. Field

One or more embodiments relate to a processor, a display device including the processor, and an electronic device including the processor.

### 2. Description of the Related Art

Display devices include a plurality of gate lines, a plurality of data lines, and a plurality of pixels located at intersections between the plurality of gate lines and the plurality of data lines. In order to apply a data voltage to each of the plurality of data lines, it is required that a data driver include a number of output lines corresponding to the number of data lines. As a plurality of integrated circuits are necessary, manufacturing costs of the display devices increase.

### SUMMARY

One or more embodiments include a processor capable of preventing or reducing an increase in power consumption that may occur when the number of output lines is reduced, a display device including the processor, and an electronic device including the processor. However, aspects of embodiments are not limited thereto, and the above characteristics do not limit the scope of embodiments according to the disclosure.

Additional aspects will be set forth in portion in the description which follows and, in part, will be apparent from the description, or may be learned by practice of the presented embodiments of the disclosure.

According to one or more embodiments, a display device includes a pixel unit including pixels connected to data lines, gate lines, and light-emission control lines, a data driver which outputs a data voltage through output lines, a data distribution circuit which connects each of the output lines to one of a pair of data lines in response to a first control signal during a first sub-frame period and connects each of the output lines to the other of the pair of data lines in response to a second control signal during a second sub-frame period, a first gate driver which sequentially outputs a first gate signal to each of first gate lines from among the gate lines during the first sub-frame period, a second gate driver which sequentially outputs a second gate signal to each of second gate lines from among the gate lines during the second sub-frame period, and a light-emission control driver which divides the light-emission control lines into groups of four and outputs light-emission control signals in units of groups.

In an embodiment, the data distribution circuit may connect each of the output lines to an odd-numbered data line from among the pair of data lines during the first sub-frame period and connect each of the output lines to an even-numbered data line from among the pair of data lines during the second sub-frame period.

In an embodiment, pixels connected to the odd-numbered data lines may be connected to the first gate lines, and pixels connected to the even-numbered data lines may be connected to the second gate lines.

In an embodiment, the data distribution circuit may connect each of odd-numbered output lines from among the output lines to an odd-numbered data line among the pair of data lines and connect each of even-numbered output lines from among the output lines to an even-numbered data line from among the pair of data lines during the first sub-frame period, and the data distribution circuit may connect each of the odd-numbered output lines from among the output lines to the even-numbered data line from among the pair of data lines and connect each of the even-numbered output lines from among the output lines to the odd-numbered data line among the pair of data lines during the second sub-frame period.

In an embodiment, the data driver may output a data voltage in synchronization with an output timing of the first control signal during the first sub-frame period, and to output a data voltage in synchronization with an output timing of the second control signal during the second sub-frame period.

In an embodiment, the pixel unit may include first pixels and second pixels, which are connected to an odd-numbered data line among the pair of data lines and alternately arranged in a column direction, and third pixels connected to an even-numbered data line from among the pair of data lines and repeatedly arranged in the column direction, where the first pixels, the second pixels and the third pixels may emit light of different colors, respectively.

In an embodiment, the data driver may alternately output a first data voltage and a second data voltage to each of the output lines in synchronization with an output timing of the first gate signal during the first sub-frame period, and output a third data voltage to each of the output lines in synchronization with an output timing of the second gate signal during the second sub-frame period.

In an embodiment, the data driver may alternately output a first color data voltage and a second color data voltage to each of odd-numbered output lines among the output lines in synchronization with the output timing of the first gate signal and output a third color data voltage to each of even-numbered output lines among the output lines in synchronization with the output timing of the first gate signal during the first sub-frame period, and the data driver may output the third color data voltage to each of the odd-numbered output lines from among the output lines in synchronization with the output timing of the second gate signal and alternately output the first color data voltage and the second color data voltage to each of the even-numbered output lines from among the output lines in synchronization with the output timing of the second gate signal during the second sub-frame period.

In an embodiment, the first gate driver may sequentially output the first gate signal to each of the first gate lines in synchronization with an output timing of the first control signal during the first sub-frame period, and the second gate driver may sequentially output the second gate signal to each of the second gate lines in synchronization with an output timing of the second control signal during the second sub-frame period.

In an embodiment, the light-emission control driver may be output the light-emission control signals in synchronization with an output timing of a first light-emission control clock signal and an output timing of a second light-emission control clock signal delayed at a preset interval from the first light-emission control clock signal.

In an embodiment, an odd-numbered light-emission control signal from among the light-emission control signals may be output in synchronization with the output timing of the first light-emission control clock signal, and an even-numbered light-emission control signal from among the light-emission control signals may be output in synchronization with the output timing of the second light-emission control clock signal.

In an embodiment, the light-emission control driver may operate once during the first sub-frame period and operate once during the second sub-frame period.

In an embodiment, the light-emission control driver may include light-emission control stages that are connected to each other in a dependent manner, and each of the light-emission control stages may be connected to a corresponding group of four light-emission control lines from among the light-emission control lines to simultaneously supply a corresponding light-emission control signal among the light-emission control signals thereto.

According to one or more embodiments, a display device includes a pixel unit including first pixels and second pixels, which are connected to a first data line and arranged alternately in a column direction, and third pixels connected to a second data line, a data driver which outputs a data voltage through output lines, a data distribution circuit which connects a first output line from among the output lines to the first data line in response to a first control signal, and connects the first output line to the second data line in response to a second control signal, a first gate driver which outputs first gate signals to the first pixels and the second pixels through first gate lines, a second gate driver which outputs second gate signals to the third pixels through second gate lines, and a light-emission control driver which outputs light-emission control signals to the first pixels, the second pixels, and the third pixels through light-emission control lines. In such embodiments, an on-voltage period of each of the light-emission control signals may overlap on-voltage periods of four consecutive first gate signals or on-voltage periods of four consecutive second gate signals.

In an embodiment, the light-emission control driver may divide the light-emission control lines into groups of four and sequentially output light-emission control signals in units of groups.

In an embodiment, one frame may include a first sub-frame period and a second sub-frame period. In such an embodiment, during the first sub-frame period, the first control signal may be output in a way such that an on voltage and an off voltage are repeated, and the second control signal may maintain the off voltage. In such an embodiment, during the second sub-frame period, the first control signal may maintain an off voltage, and the second control signal may be output in a way such that an on voltage and an off voltage are repeated.

In an embodiment, the data driver may output the data voltage in synchronization with an output timing of the first gate signals during the first sub-frame period, and output the data voltage in synchronization with an output timing of the second gate signals during the second sub-frame period.

In an embodiment, each of the first pixels may emit light of a first color, each of the second pixels may emit light of a second color, and each of the third pixels may emit light of a third color, and the data driver may alternately output a first data voltage and a second data voltage to each of the output lines during the first sub-frame period, and repeatedly output a third data voltage to each of the output lines during the second sub-frame period.

In an embodiment, the first gate driver may output each of the first gate signals in synchronization with an output timing of the first control signal, and the second gate driver may output each of the second gate signals in synchronization with an output timing of the second control signal.

In an embodiment, the light-emission control driver may output the light-emission control signals in synchronization with a first light-emission control clock signal and a second light-emission control clock signal delayed at a preset interval from the first light-emission control clock signal.

In an embodiment, an odd-numbered light-emission control signal from among the light-emission control signals may be output in synchronization with an output timing of the first light-emission control clock signal, and an even-numbered light-emission control signal from among the light-emission control signals may be output in synchronization with an output timing of the second light-emission control clock signal.

According to one or more embodiments, a processor may include a graphics memory, an input circuit which receives an image signal and converts the image signal to generate image data, a first data processing circuit which stores the image data in the graphics memory according to an inputting order, and a second data processing circuit which reads pieces of sub-data corresponding to pixels driven during a first sub-frame period from the image data stored in the graphics memory and outputs the read-out pieces of sub-data to an output channel, and reads pieces of sub-data corresponding to pixels driven during a second sub-frame period and outputs the read-out pieces of sub-data to the output channel.

In an embodiment, the first data processing circuit may store the image data in the graphics memory during a first period, the second data processing circuit may read the pieces of sub-data and output the read-out pieces of sub-data to the output channel during a second period, where a portion of the first period may overlap the second period.

In an embodiment, a start timing of the second period may be delayed by half a frame from a start timing of the first period.

In an embodiment, the image data may include pieces of pixel pair data including two pieces of sub-data, and the second data processing circuit may read pieces of odd-numbered sub-data from the pieces of pixel pair data and output the read-out pieces of odd-numbered sub-data to the output channel during the first sub-frame period, and the second data processing circuit may read pieces of even-numbered sub-data from the pieces of pixel pair data and output the read-out pieces of even-numbered sub-data to the output channel during the second sub-frame period.

In an embodiment, the image data may include pieces of pixel pair data including two pieces of sub-data. In such an embodiment, the second data processing circuit may read pieces of odd-numbered sub-data from odd-numbered pieces of pixel pair data from among the pieces of pixel pair data and read pieces of even-numbered sub-data from even-numbered pieces of pixel pair data from among the pieces of pixel pair data and output the read-out pieces of even-numbered sub-data to the output channel during the first sub-frame period, and the second data processing circuit may read pieces of even-numbered sub-data from the odd-numbered pieces of pixel pair data from among the pieces of pixel pair data and read pieces of odd-numbered sub-data from the even-numbered pieces of pixel pair data among the pieces of pixel pair data and output the read-out pieces of odd-numbered sub-data to the output channel during the second sub-frame period.

In an embodiment, the processor may further include a register memory which stores a register signal, and the second data processing circuit may be turned on or off based on a value of the register signal.

According to one or more embodiments, an electronic device includes a display module, and a processor which controls the display module, wherein the processor includes a graphics memory, an input circuit which receives an image signal and convert the image signal to generate image data, a first data processing circuit which stores the image data in the graphics memory according to an inputting order, and a second data processing circuit which reads pieces of sub-data corresponding to pixels driven during a first sub-frame period from the image data stored in the graphics memory and outputs the read-out pieces of sub-data to an output channel, and reads pieces of sub-data corresponding to pixels driven during a second sub-frame period and outputs the read-out pieces of sub-data to the output channel.

In an embodiment, the display module may include a pixel unit including pixels connected to data lines, gate lines, and light-emission control lines, a data driver which outputs a data voltage through output lines, output lines connected to the data driver, a data distribution circuit which connects each of the output lines to one of a pair of data lines in response to a first control signal during a first sub-frame period and to connects each of the output lines to the other of the pair of data lines in response to a second control signal during a second sub-frame period, a first gate driver which sequentially outputs a first gate signal to each of first gate lines from among the gate lines during the first sub-frame period, and a second gate driver which sequentially outputs a second gate signal to each of second gate lines from among the gate lines during the second sub-frame period.

In an embodiment, the display module may further include a light-emission control driver which divides the light-emission control lines into groups of four and output light-emission control signals in units of groups.

In an embodiment, the data distribution circuit may connect each of the output lines to an odd-numbered data line from among the pair of data lines during the first sub-frame period and t connect each of the output lines to an even-numbered data line from among the pair of data lines during the second sub-frame period.

In an embodiment, the image data may include pieces of pixel pair data including two pieces of sub-data, and the second data processing circuit may read pieces of odd-numbered sub-data from the pieces of pixel pair data and output the read-out pieces of odd-numbered sub-data to the output channel during the first sub-frame period, and read pieces of even-numbered sub-data from the pieces of pixel pair data and output the read-out pieces of even-numbered sub-data to the output channel during the second sub-frame period.

In an embodiment, the data distribution circuit may connect each of odd-numbered output lines from among the output lines to an odd-numbered data line from among the pair of data lines and connect each of even-numbered output lines from among the output lines to an even-numbered data line from among the pair of data lines during the first sub-frame period, and the data distribution circuit may connect each of the odd-numbered output lines from among the output lines to the even-numbered data line from among the pair of data lines and connect each of the even-numbered output lines from among the output lines to the odd-numbered data line from among the pair of data lines during the second sub-frame period.

In an embodiment, the image data may include pieces of pixel pair data including two pieces of sub-data. In such an embodiment, the second data processing circuit may read pieces of odd-numbered sub-data from odd-numbered pieces of pixel pair data from among the pieces of pixel pair data, and read pieces of even-numbered sub-data from even-numbered pieces of pixel pair data from among the pieces of pixel pair data and output the read-out pieces of even-numbered sub-data to the output channel during the first sub-frame period, and the second data processing circuit may read pieces of even-numbered sub-data from the odd-numbered pieces of pixel pair data from among the pieces of pixel pair data, and read pieces of odd-numbered sub-data from the even-numbered pieces of pixel pair data from among the pieces of pixel pair data and output the read-out pieces of odd-numbered sub-data to the output channel during the second sub-frame period.

### BRIEF DESCRIPTION OF THE DRAWINGS

The above and other features of certain embodiments of the disclosure will be more apparent from the following description taken in conjunction with the accompanying drawings, in which:

FIGS. 1A and 1B are schematic plan views of a display device according to an embodiment;

FIG. 2 is a schematic block diagram of a display device according to an embodiment;

FIGS. 3A and 3B are schematic equivalent circuit diagrams of a pixel according to an embodiment;

FIG. 4A is a schematic drawing for explaining respective operations of a display unit and a data distribution circuit according to an embodiment;

FIG. 4B is a signal timing diagram for schematically explaining an operation of the display device illustrated in FIG. 4A;

FIG. 5A is a drawing for explaining a data voltage applied to an output line during a first sub-frame period of the display device, and FIG. 5B is a drawing for explaining a data voltage applied to an output line during a second sub-frame period of the display device.

FIG. 6A is a schematic drawing for explaining respective operations of a display unit and a data distribution circuit according to another embodiment;

FIG. 6B is a signal timing diagram for schematically explaining an operation of the display device illustrated in FIG. 6A;

FIG. 7 is a schematic diagram of a display device according to an embodiment;

FIG. 8 is a signal timing diagram for schematically explaining an operation of the display device illustrated in FIG. 7;

FIG. 9 is a schematic block diagram of an electronic device according to an embodiment;

FIG. 10 is a block diagram for explaining a driver integrated circuit (IC) according to an embodiment; and

FIGS. 11A and 11B are diagrams for schematically explaining an operation of a driver IC according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

As the disclosure allows for various changes and numerous embodiments, particular embodiments will be illustrated in the drawings and described in detail in the written description. Hereinafter, effects and features of the disclosure and a method for accomplishing them will be described more fully with reference to the accompanying drawings, in which embodiments of the disclosure are shown. The disclosure may, however, be embodied in many different forms and should not be construed as limited to the embodiments set forth herein.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on” another element, it can be directly on the other element or intervening elements may be present therebetween. In contrast, when an element is referred to as being “directly on” another element, there are no intervening elements present.

When a layer, region, or component is referred to as being “connected” or “coupled” to another layer, region, or component, it can be directly connected or coupled to the other layer, region, or/and component or intervening layers, regions, or components may be present. For example, when a layer, region, or component is referred to as being “electrically connected” or “electrically coupled” to another layer, region, or component, it can be directly electrically connected or coupled to the other layer, region, and/or component or intervening layers, regions, or components may be present.

As used herein, the term “and/or” includes any and all combinations of one or more of the associated listed items. In the present specification, “A and/or B” represents A or B, or A and B. The expression “at least one of A and B” or “at least one selected from A and B” indicates only A, only B, both A and B, or variations thereof. Throughout the disclosure, the expression “at least one of a, b or c” or “at least one selected from a, b and c” indicates only a, only b, only c, both a and b, both a and c, both b and c, all of a, b, and c, or variations thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

An x direction, a y direction, and a z direction used herein are not limited to directions along three axes of a rectangular coordinate system, and may be interpreted in a broader sense. For example, the x direction, the y direction, and the z direction may be perpendicular to one another, or may represent different directions that are not perpendicular to one another.

In the present specification, when referred to “planar”, it means when an object is viewed from above (e.g., when an object is viewed in a direction perpendicular to an upper surface of a substrate), and when referred to “sectional”, it means when a cross section formed by vertically cutting an object is viewed from the side.

In the present specification, a first component “overlapping” a second component refers to the first component being located above or below the second component and accordingly at least partially overlapping the second component.

In the present specification, “ON” or “on” used in association with an element state may be referred to as an activated state of an element, and “OFF” or “off” may be referred to as an inactivated state of an element. “ON” or “on” used in association with a signal received by an element may be referred to as a signal for activating the element, and “OFF” or “off” may be referred to as a signal for inactivating the element. An element may be activated by a high-level voltage or a low-level voltage. For example, a P-channel transistor (P-type transistor) is activated by a low-level voltage, and an N-channel transistor (N-type transistor) is activated by a high-level voltage. Therefore, it should be understood that an “ON” voltage for a P-type transistor and an “ON” voltage for an N-type transistor have opposite (high versus low) voltage levels.

When a certain embodiment may be implemented differently, a specific process order may be performed differently from the described order. For example, two consecutively described processes may be performed substantially at the same time or performed in an order opposite to the described order.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Sizes of elements in the drawings may be exaggerated or reduced for convenience of illustration and description. For example, since sizes and thicknesses of components in the drawings are arbitrarily illustrated for convenience of illustration and description, embodiments are not limited thereto.

One or more embodiments will be described below in more detail with reference to the accompanying drawings. Those components that are the same as or are in correspondence with each other are rendered the same reference numeral regardless of the figure number, and any repetitive detailed description thereof will be omitted or simplified.

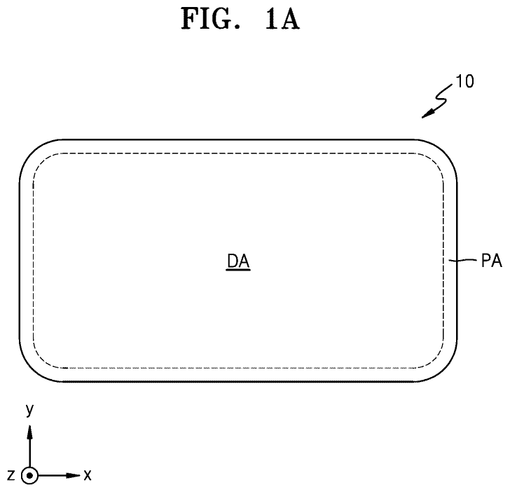

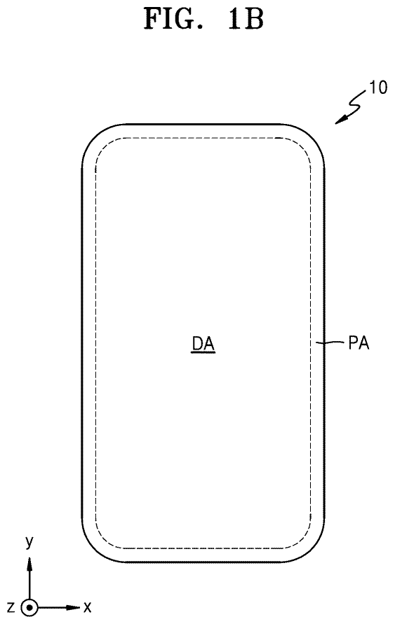

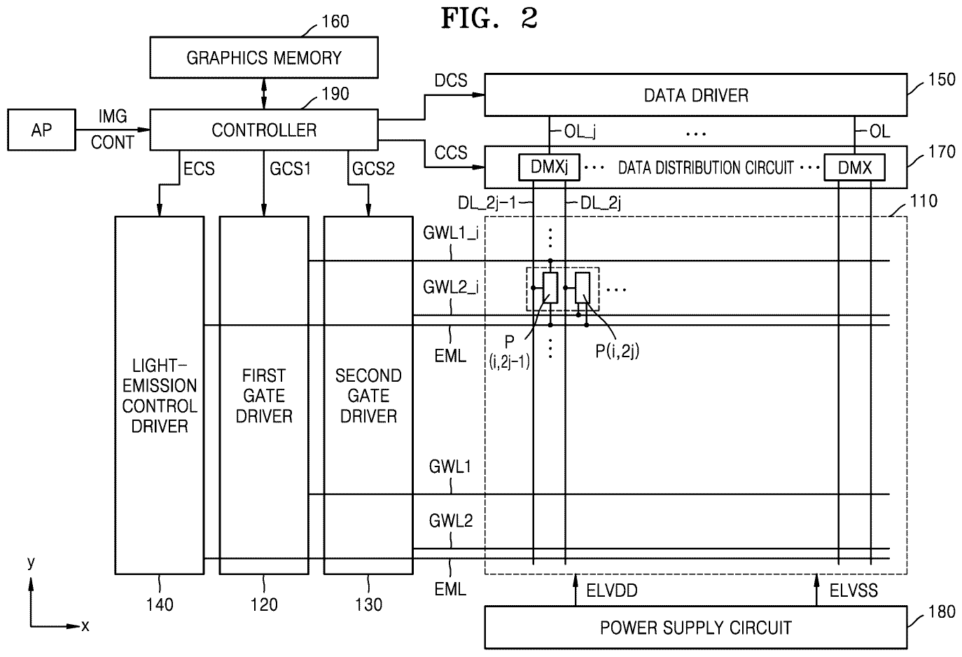

FIG. 1A and FIG. 1B are schematic plan views of a display device 10 according to an embodiment, and FIG. 2 is a schematic block diagram of the display device 10 according to an embodiment.

Referring to FIGS. 1A and 1B, an embodiment of the display device 10 may include a display area DA in which an image is displayed and a peripheral area PA around the display area DA. The display area DA may be entirely surrounded by the peripheral area PA in a plan view or when viewed in a third direction (z direction). Here, the third direction or the z direction may be a thickness direction of the display device 10.

In a plan view, the display panel DA may have a rectangular shape. According to another embodiment, the display area DA may have any other polygonal shape (e.g., a triangular shape, a pentagonal shape, or a hexagonal shape), a circular shape, an elliptical shape, an irregular shape, or the like. The display area DA may have a shape with rounded corners. According to an embodiment, the display device 10 may have a display area DA having a shape with a length in a first direction (e.g., an x direction or a row direction) greater than a length in a second direction (e.g., a y direction or a column direction), as shown in FIG. 1A. According to another embodiment, the display device 10 may have a display area DA having a shape with a length in the second direction (e.g., the y direction) greater than a length in the first direction (e.g., the x direction), as shown in FIG. 1B.

Referring to FIG. 2, the display device 10 according to an embodiment may include a pixel unit (or display unit) 110, a first gate driver 120, a second gate driver 130, a light-emission control driver 140, a data driver 150, a data distribution circuit 170, a power supply circuit 180, and a controller 190.

The pixel unit 110 may be included in the display area DA. Various conductive lines for transmitting electric signals to be applied to the display area DA, external circuits electrically connected to pixel circuits, and pads to which a printed circuit board (PCB) or a driver integrated circuit (IC) chip is attached may be located in the peripheral area PA. In an embodiment, for example, the first gate driver 120, the second gate driver 130, the light-emission control driver 140, the data driver 150, a graphics memory 160, the data distribution circuit 170, and the controller 190 may be included in the peripheral area PA.

In an embodiment, as shown in FIG. 2, a plurality of pixels PX connected to a plurality of gate lines GWL1 and GWL2, a plurality of light-emission control lines EML, and a plurality of data lines DL may be arranged in the pixel unit 110. The plurality of pixels PX may be arranged in any of various configurations, such as a stripe configuration, a PenTile™ (diamond) configuration, and a mosaic configuration, to realize an image. Each of the plurality of pixels P may include a display element (light-emitting device) and a pixel circuit connected to the display element. The display element may be an organic light-emitting diode. The pixel circuit may include a plurality of transistors and at least one capacitor. The pixel P may emit, for example, red light, green light, blue light, or white light via the display element. Each of the plurality of pixels P may be connected to a corresponding gate line among the plurality of gate lines GWL1 and GWL2, a corresponding control line among the plurality of light-emission control lines EML, and a corresponding data line among the plurality of data lines DL.

The plurality of gate lines GWL1 and GWL2 may include first gate lines GWL1 and second gate lines GWL2. Each of the first gate lines GWL1 and the second gate lines GWL2 may extend in the first direction (x direction) and may be connected to pixels P located in a same row. Two adjacent pixels P located in a same row may be defined as one pixel pair. The one pixel pair may include one pixel P connected to a first gate line GWL1 and another pixel P connected to a second gate line GWL2. In an embodiment, for example, an i-th first gate line GWL1_i may be connected to pixels P(i, 2-j-1) located in odd columns among pixels located in an i-th row to transmit a first gate signal. An i-th second gate line GWL2_i may be connected to pixels P(i, 2-j) located in even columns among the pixels located in the i-th row to transmit a second gate signal. Here, i and j are natural numbers equal to or greater than 1. Each of the plurality of data lines DL may extend in the second direction (y direction) and may be connected to pixels P located in the same column to transmit a data voltage. Each of the plurality of light-emission control lines EML may extend in the first direction (x direction) and may be connected to pixels P located in the same row to transmit a light-emission control signal.

The first gate driver 120 may be connected to the plurality of first gate lines GWL1, may generate a first gate signal based on a first gate driving control signal GCS1 received from the controller 190, and may sequentially supply the first gate signal to the plurality of first gate lines GWL1. When the first gate signal is sequentially supplied to the first gate lines GWL1, pixels connected to the first gate lines GWL1 may be selected in units of rows. The data lines DL may transmit data voltages to pixels connected to the first gate line GWL1 in a selected row.

The second gate driver 130 may be connected to the plurality of second gate lines GWL2, may generate a second gate signal based on a second gate driving control signal GCS2 received from the controller 190, and may sequentially supply the second gate signal to the plurality of second gate lines GWL2. When the second gate signal is sequentially supplied to the second gate lines GWL2, pixels connected to the second gate lines GWL2 may be selected in units of rows. The data lines DL may transmit data voltages to pixels connected to the second gate line GWL2 in a selected row.

Each of the first gate line GWL1 and the second gate line GWL2 may be connected to a gate of a data write transistor included in pixels. Each of the first gate signal and the second gate signal may be a gate control signal for controlling turn-on and turn-off operations of a data write transistor. Each of the first gate signal and the second gate signal may be a square wave signal in which an on-voltage for turning on a data write transistor and an off-voltage for turning off the data write transistor are repeated.

The light-emission control driver 140 may be connected to the plurality of light-emission control lines EML, may generate a light-emission control signal based on a light-emission control driving control signal ECS from the controller 190, and may supply the light-emission control signal to the plurality of light-emission control lines EML. According to an embodiment, the light-emission control driver 140 may group (or divide) the plurality of light-emission control lines EML into groups of four and output light-emission control signals in units of groups (or on a group-by-group basis).

The data driver 150 may be connected to a plurality of output lines OL, and the plurality of output lines OL may be connected to the plurality of data lines DL through the data distribution circuit 170. The data driver 150 may convert an image signal IMG received from an application processor (AP) into a data signal in the form of a voltage, based on a data driving control signal DCS received from the controller 190. The data driver 150 may supply the data voltage to the data distribution circuit 170 through the output lines OL.

The data distribution circuit 170 may be connected between the plurality of output lines OL and the plurality of data lines DL. The data distribution circuit 170 may include demultiplexers DMX including a plurality of switches. The data distribution circuit 170 may include demultiplexers DMX, the number of which is the same as the number of output lines OL. One end of each of the demultiplexers DMX may be connected to a corresponding output line among the plurality of output lines OL. The other end of each of the demultiplexers DMX may be connected to a pair of data lines including one odd-numbered data line and one even-numbered data line. In an embodiment, for example, an j-th demultiplexer DMX_j may supply a data voltage received from a j-th output line OL_j to a (2j-1)-th data line DL_2j-1 and a 2-j-th data line DL_2j. Here, j may be a natural number equal to or greater than 1.

According to an embodiment, pixels connected to an odd-numbered data line may be connected to first gate lines GWL1, and pixels connected to an even-numbered data line may be connected to second gate lines GWL2. In an embodiment, for example, a pixel P(i,2j-1) located in an i-th row and connected to the (2j-1)-th data line DL_2j-1 may be connected to an i-th first gate line GWL1_i, and a pixel P(i,2j) located in the i row and connected to the 2-j-th data line DL_2j may be connected to an i-th second gate line GWL2_i. Here, i and j may be natural numbers equal to or greater than 1.

According to another embodiment, pixels connected to an odd-numbered data line among a pair of data lines connected to an odd-numbered output line may be connected to first gate lines GWL1, and pixels connected to an even-numbered data line among a pair of data lines connected to an odd-numbered output line may be connected to second gate lines GWL2. Pixels connected to an odd-numbered data line among a pair of data lines connected to an even-numbered output line may be connected to second gate lines GWL2, and pixels connected to an even-numbered data line among a pair of data lines connected to an even-numbered output line may be connected to first gate lines GWL1.

By using a demultiplexer DMX, less output lines OL than data lines DL are used, thereby reducing the number of output lines OL connected to the data driver 150 and also leading to a reduction in the manufacturing costs. A demultiplexer DMX may include two switches connected between a corresponding output line OL and each of two data lines.

The power supply circuit 180 may supply a first driving voltage ELVDD and a second driving voltage ELVSS to the pixels P of the pixel unit 110. The first driving voltage ELVDD may be a high-level voltage that is provided to a first electrode (i.e., a pixel electrode or an anode) of a display element included in each pixel P. The second driving voltage ELVSS may be a low-level voltage that is provided to a second electrode (i.e., an opposite electrode or a cathode) of a display element included in each pixel P. The first power supply voltage ELVDD and the second power supply voltage ELVSS may be driving voltages for enabling the plurality of pixels P to emit light. The power supply circuit 180 may generate a first initializing voltage, a bias voltage, etc., and may supply them to the pixels P of the pixel unit 110.

The controller 190 may generate the first gate drive control signal GCS1, the second gate drive control signal GCS2, the light-emission control driving control signal ECS, and the data driving control signal DCS based on the image signal IMG and control signals CONT received from the AP. The controller 190 may output the first gate driving control signal GCS1 to the first gate driver 120, may output the second gate driving control signal GCS2 to the second gate driver 130, may output the light-emission control driving control signal ECS to the light-emission control driver 140, and may output the data driving control signal DCS to the data driver 150. The controller 190 may output a distribution control signal CCS to the data distribution circuit 170, and the data distribution circuit 170 may selectively connect output lines OL and data lines DL in response to the distribution control signal CCS. The controller 190 may output two distribution control signals CCS to demultiplexers DMX such that a data voltage supplied to one output line is time-multiplexed and supplied to a pair of data lines. The two distribution control signals CCS may be sequentially output not to overlap each other. The controller 190 may remap image data according to a driving order of the pixels P. In an embodiment, for example, the controller 190 may receive the image signal IMG from the AP, decode the received image signal IMG into the image data, and store the image data in the graphics memory 160 in an inputting order. The controller 190 may read the image data stored in the graphics memory 160 in the order of driving the pixels P, and may transmit the read-out image data to the data driver 150.

The first gate driver 120, the second gate driver 130, and the light-emission control driver 140 may be formed directly on a substrate. The data driver 150, the graphics memory 160, the power supply circuit 180, and/or the controller 190 may be arranged on a flexible printed circuit board (FPCB) electrically connected to a pad disposed on one side of the substrate. According to another embodiment, the data driver 150, the graphics memory 160, the power supply circuit 180, and/or the controller 190 may be directly arranged on the substrate by using a chip on glass (COG) or chip on plastic (COP) method. According to an embodiment, the graphics memory 160, the power supply circuit 180, and the controller 190 may be integrated into one integrated circuit. In an embodiment, for example, the power supply circuit 180, the controller 190, and the graphics memory 160 may each be included as a timing controller embedded driver integrated circuit (T-con Embedded Driver IC).

Although an organic light-emitting display including an organic light-emitting diode as a display element will now be illustrated and described as the display device 10 according to an embodiment, a display device according to the disclosure is not limited thereto. According to another embodiment, the display device 10 may be, for example, an inorganic light-emitting display, a quantum dot light-emitting display, or the like.

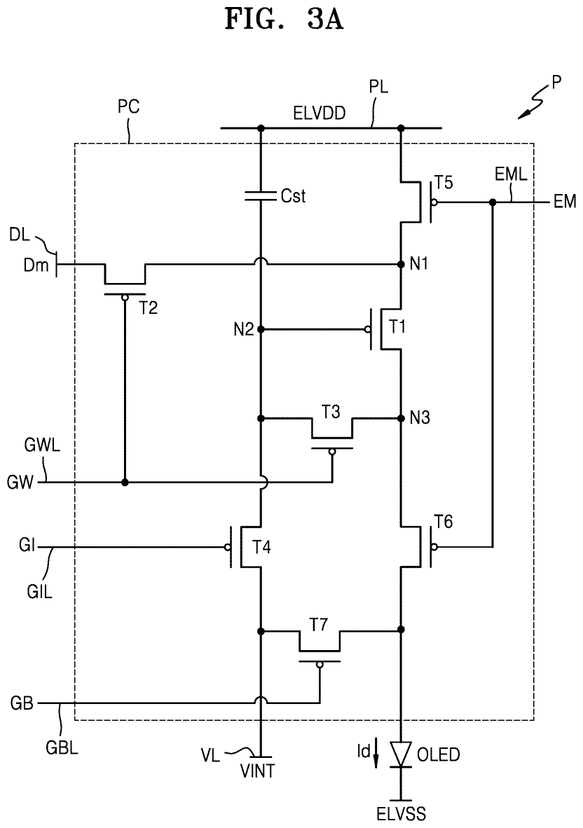

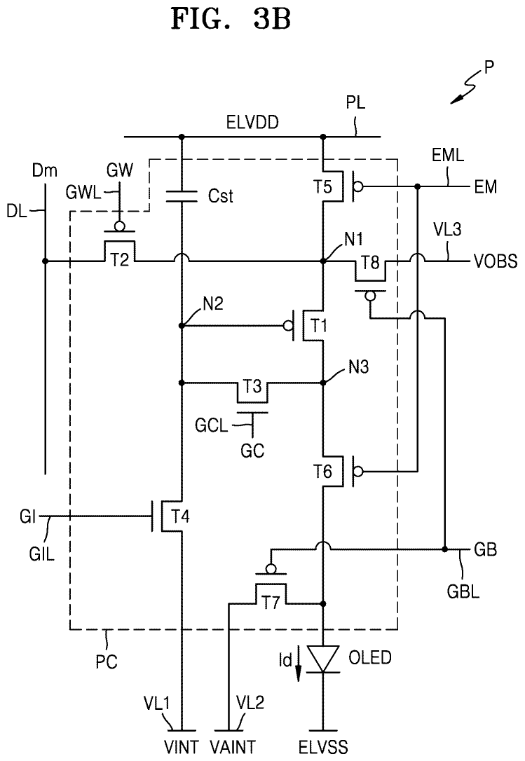

FIGS. 3A and 3B are schematic equivalent circuit diagrams of a pixel according to an embodiment.

Referring to FIG. 3A, in an embodiment, a pixel circuit PC may include first, second, third, fourth, fifth, sixth, and seventh transistors T1, T2, T3, T4, T5, T6, and T7, and a storage capacitor Cst. According to the type (p-type or n-type) of transistor and/or operating conditions thereof, a first terminal of each of the first through seventh transistors T1 through T7 may be a source or a drain, and a second terminal thereof may be a different terminal than the first terminal. For example, when the first terminal is a source, the second terminal may be a drain. The first transistor T1 may be a driving transistor in which the magnitude of a source-drain current is determined based on a gate-source voltage, and the second through seventh transistors T2 through T7 may be switching transistors that are turned on or off based on the gate-source voltage or a gate voltage.

The pixel circuit PC may be connected to a data write gate line GWL that transmits a data write gate signal GW, a third gate line GIL that transmits a third gate signal GI, a fourth gate line GBL that transmits a fourth gate signal GB, a light-emission control line EL that transmits a light-emission control signal EM, a data line DL that transmits a data voltage Dm, a driving voltage line PL that transmits a first driving voltage ELVDD, and an initializing voltage line VL that transmits an initializing voltage VINT.

The data write gate line GWL may correspond to one of the first gate line GWL1 and the second gate line GWL2 described above with reference to FIG. 2. In an embodiment, for example, two pixels P arranged in a same row and adjacent to each other may be defined as one pixel pair, a data write gate line GWL of (or connected to) one of the two pixels P constituting the one pixel pair may be the first gate line GWL1, and a data write gate line GWL of (or connected to) the other pixel P may be a second gate line GWL2. The data write gate signal GW transmitted by the first gate line GWL1 may be a first gate signal, and the data write gate signal GW transmitted by the second gate line GWL2 may be a second gate signal.

The first transistor T1 may be a driving transistor. The first transistor T1 may include a gate connected to a second node N2, a first terminal connected to a first node N1, and a second terminal connected to a third node N3. The first transistor T1 receives the data voltage Dm based on a switching operation of the second transistor T2 and supplies a driving current Id to a light-emitting device. The light-emitting device may be an organic light-emitting diode OLED.

The second transistor T2 may be a data write transistor. The second transistor T2 may include a gate connected to the data write gate line GWL, a first terminal connected to the data line DL, and a second terminal connected to the first node N1. The second transistor T2 may be turned on in response to the data write gate signal GW received through the data write gate line GWL, to perform a switching operation of transmitting the data voltage Dm received through the data line DL to the first node N1.

The third transistor T3 may be a compensation transistor. The third transistor T3 may include a gate connected to the data write gate line GWL, a first terminal connected to the second node N2, and a second terminal connected to the third node N3. The third transistor T3 may be turned on in response to the data write gate signal GW received via the data write gate line GWL, to thereby diode-connect the first transistor T1.

The fourth transistor T4 may be a first initialization transistor. The fourth transistor T4 may include a gate connected to the third gate line GIL, a first terminal connected to the initializing voltage line VL, and a second terminal connected to the second node N2. The fourth transistor T4 may be turned on in response to the third gate signal GI received through the third gate line GIL, to transmit the first initializing voltage VINT to the gate of the first transistor T1 to thereby initialize the gate voltage of the first transistor T1.

The fifth transistor T5 may be a first light-emission control transistor, and the sixth transistor T6 may be a second light-emission control transistor. The fifth transistor T5 may include a gate connected to the light-emission control line EML, a first terminal connected to the driving voltage line PL, and a second terminal connected to the first node N1. The sixth transistor T6 may include a gate connected to the light-emission control line EML, a first terminal connected to the third node N3, and a second terminal connected to a first electrode of the organic light-emitting diode OLED. The fifth transistor T5 and the sixth transistor T6 may be simultaneously turned on in response to the light-emission control signal EM received via the light-emission control line EML, and thus the driving current Id may flow in the organic light-emitting diode OLED.

The seventh transistor T7 may be a second initialization transistor. The seventh transistor T7 may include a gate connected to the fourth gate line GBL, a first terminal connected to the second terminal of the sixth transistor T6 and a pixel electrode of the organic light-emitting diode OLED, and a second terminal connected to the initializing voltage line VL. The seventh transistor T7 may be turned on in response to the fourth gate signal GB received via the fourth gate line GBL to transmit the initializing voltage VINT to the pixel electrode of the organic light-emitting diode OLED and initialize the first electrode (i.e., the pixel electrode or an anode) of the organic light-emitting diode OLED. The seventh transistor T7 may be omitted.

The storage capacitor Cst may include a first capacitor electrode connected to the second node N2 and a second capacitor electrode connected to the driving voltage line PL.

The organic light-emitting diode OLED may include the first electrode and a second electrode (i.e., a common electrode or a cathode) facing the first electrode, and the second electrode may receive the second driving voltage ELVSS. The organic light-emitting diode OLED may receive the driving current Id from the first transistor T1 and emit light in a predetermined color, thereby displaying an image.

Referring to FIG. 3B, in another embodiment, a pixel circuit PC may include first, second, third, fourth, fifth, sixth, seventh, and eighth transistors T1, T2, T3, T4, T5, T6, T7, and T8 and a storage capacitor Cst. The first transistor T1 may be a driving transistor in which the magnitude of a source-drain current is determined according to a gate-source voltage, and the second through eighth transistors T2 through T8 may be switching transistors that transmit signals.

The pixel circuit PC may be connected to a data write gate line GWL that transmits a data write gate signal GW, a third gate line GIL that transmits a third gate signal GI, a fourth gate line GBL that transmits a fourth gate signal GB, a fifth gate line GCL that transmits a fifth gate signal GC, a light-emission control line EML that transmits a light-emission control signal EM, a data line DL that transmits a data voltage Dm, a driving voltage line PL that transmits a first driving voltage ELVDD, a first initializing voltage line VL1 that transmits a first initializing voltage VINT, a second initializing voltage line VL2 that transmits a second initializing voltage VAINT, and a bias voltage line VL3 that transmits a bias voltage VOBS.

The data write gate line GWL may correspond to one of the first gate line GWL1 and the second gate line GWL2 described above with reference to FIG. 2. The data write gate signal GW transmitted by the first gate line GWL1 may be a first gate signal, and the data write gate signal GW transmitted by the second gate line GWL2 may be a second gate signal.

The first transistor T1 may include a gate connected to a second node N2, a first terminal connected to a first node N1, and a second terminal connected to a third node N3. The first transistor T1 receives the data voltage Dm based on a switching operation of the second transistor T2 and supplies a driving current Id to a light-emitting device.

The second transistor T2 may be a data write transistor. The second transistor T2 may include a gate connected to the data write gate line GWL, a first terminal connected to the data line DL, and a second terminal connected to the first node N1. The second transistor T2 may be turned on in response to the data write gate signal GW received through the data write gate line GWL, to perform a switching operation of transmitting the data voltage Dm received through the data line DL to the first node N1.

The third transistor T3 may be a compensation transistor. The third transistor T3 may include a gate connected to the fifth gate line GCL, a first terminal connected to the second node N2, and a second terminal connected to the third node N3. The third transistor T3 may be turned on in response to the fifth gate signal GC received via the fifth gate line GCL and diode-connect the first transistor T1.

The fourth transistor T4 may be a first initialization transistor. The fourth transistor T4 may include a gate connected to the third gate line GIL, a first terminal connected to the first initializing voltage line VL1, and a second terminal connected to the second node N2. The fourth transistor T4 may be turned on in response to the third gate signal GI received through the third gate line GIL, to transmit the first initializing voltage VINT to the gate of the first transistor T1 to thereby initialize the gate voltage of the first transistor T1.

The fifth transistor T5 may be a first light-emission control transistor, and the sixth transistor T6 may be a second light-emission control transistor. The fifth transistor T5 may include a gate connected to the light-emission control line EML, a first terminal connected to the driving voltage line PL, and a second terminal connected to the first node N1. The sixth transistor T6 may include a gate connected to the light-emission control line EML, a first terminal connected to the third node N3, and a second terminal connected to a first electrode of the organic light-emitting diode OLED. The fifth transistor T5 and the sixth transistor T6 may be simultaneously turned on in response to the light-emission control signal EM received via the light-emission control line EML, and thus the driving current Id may flow in the organic light-emitting diode OLED.

The seventh transistor T7 may be a second initialization transistor. The seventh transistor T7 may include a gate connected to the fourth gate line GBL, a first terminal connected to the second terminal of the sixth transistor T6 and the pixel electrode of the organic light-emitting diode OLED, and a second terminal connected to the second initializing voltage line VL2. The seventh transistor T7 may be turned on in response to the fourth gate signal GB received via the fourth gate line GBL to transmit the second initializing voltage VAINT from the second initializing voltage line VL2 to the first electrode of the organic light-emitting diode OLED and initialize the first electrode of the organic light-emitting diode OLED.

The eighth transistor T8 may be an on-device control transistor. The eighth transistor T8 may include a gate connected to the fourth gate line GBL, a first terminal connected to the first node N1, and a second terminal connected to the bias voltage line VL3. The eighth transistor T8 may be turned on in response to the fourth gate signal GB received via the fourth gate line GBL to transmit the bias voltage VOBS from the bias voltage line VL3 to the first node N1.

The storage capacitor Cst may include a first capacitor electrode connected to the second node N2 and a second capacitor electrode connected to the driving voltage line PL.

The organic light-emitting diode OLED may include the first electrode and a second electrode facing the first electrode, and the second electrode may receive the second driving voltage ELVSS. The organic light-emitting diode OLED may receive the driving current Id from the first transistor T1 and emit light in a predetermined color, thereby displaying an image.

In an embodiment, as shown in FIG. 3A, the transistors of the pixel circuit PC are P-type transistors. However, embodiments are not limited thereto. In another embodiment, for example, the transistors of the pixel circuit PC may be N-type transistors, or, as shown in FIG. 3B, some of the transistors of the pixel circuit PC may be P-type transistors and the others may be N-type transistors. In an embodiment, for example, the third transistor T3 and the fourth transistor T4 may be N-type transistors, and the remaining transistors may be P-type transistors. The pixel circuits PC of FIGS. 3A and 3B are merely examples, and the pixel circuits PC according to embodiments of the disclosure may be designed or modified in various other ways.

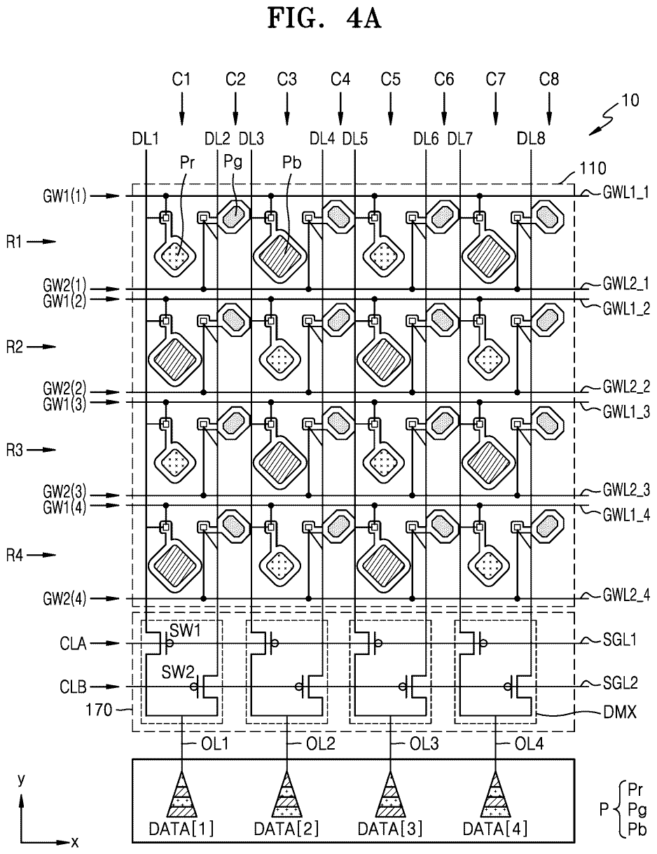

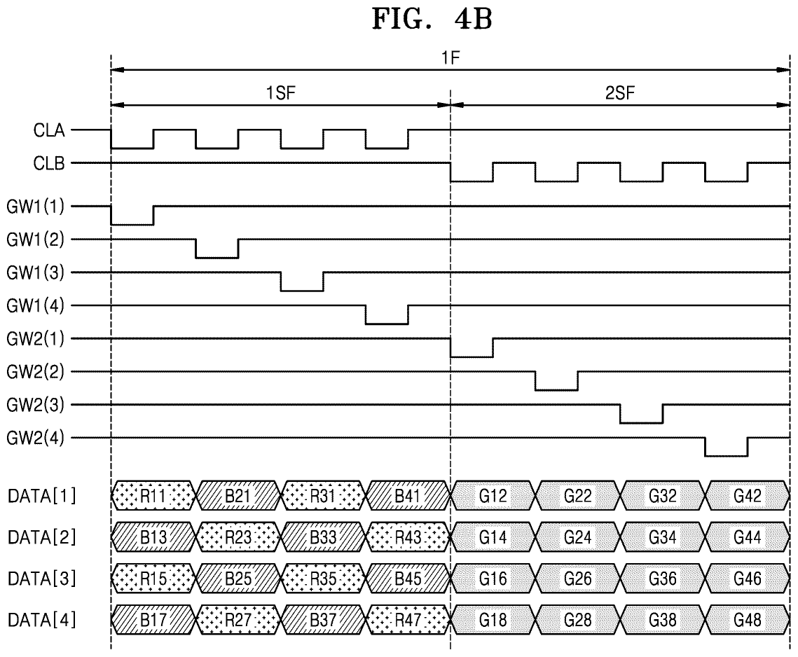

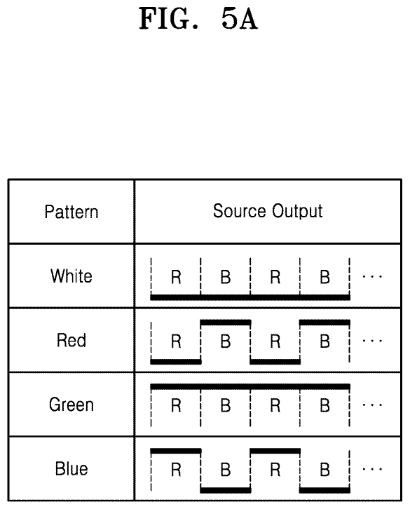

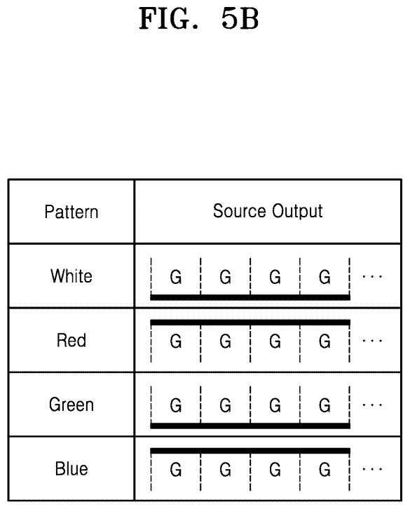

FIG. 4A is a schematic drawing for explaining respective operations of the pixel unit 110 and the data distribution circuit 170 according to an embodiment, and FIG. 4B is a signal timing diagram for schematically explaining an operation of the display device 10 illustrated in FIG. 4A. FIG. 5A is a drawing for explaining a data voltage applied to an output line during a first sub-frame period of the display device 10 illustrated in FIG. 4A, and FIG. 5B is a drawing for explaining a data voltage applied to an output line during a second sub-frame period of the display device 10 illustrated in FIG. 4A.

Referring to FIGS. 4A and 4B, an embodiment of the display device 10 may include the pixel unit 110 and the data distribution circuit 170. The pixel unit 110 may be included in the display area DA, and the data distribution circuit 170 may be included in the peripheral area PA.

The pixel unit 110 may include a plurality of pixels P connected to a plurality of gate lines GWL1 and GWL2 and a plurality of data lines DL. The plurality of pixels P may be arranged in any of various configurations, such as a stripe configuration, a PenTile™ (diamond) configuration, and a mosaic configuration. In an embodiment, the plurality of pixels P are arranged in a PenTile™ configuration as shown in FIG. 4A. However, embodiments are not limited thereto.

Each of the plurality of pixels P may include a display element and a pixel circuit connected to the display element. For convenience of illustration and description, FIG. 4A illustrates each of a plurality of pixel P based on a display element. However, it may be understood that the first gate lines GWL1, the second gate lines GWL2, and the data lines DL are connected to respective pixel circuits of the plurality of pixel P.

The plurality of pixels P may be arranged in an n×m matrix form. Here, n and m are natural numbers equal to or greater than 1. FIG. 4A illustrates the plurality of pixels P arranged in a 4×8 matrix form. However, embodiments are not limited thereto. The plurality of pixels P may include first pixels Pr that emit light in a first color, second pixels Pb that emit light in a second color, and third pixels Pg that emit light in a third color. The first color, the second color, and the third color may be red, blue and green, respectively. In odd columns of a pixel matrix, i.e., in odd-numbered pixel columns, first pixels Pr and second pixels Pb may be arranged alternately in the second direction (y direction). In even columns of the pixel matrix, i.e., in even-numbered pixel columns, second pixels Pb may be arranged repeatedly in the second direction (y direction). Two pixels P adjacent to each other and arranged in a same row may be defined as one pixel pair. The two pixels P included in one pixel pair may be respectively connected to two data lines DL connected to a same output line OL. In an embodiment, for example, a first pixel Pr disposed in a first row R1 and a first column C1 of the pixel matrix and a third pixel Pg disposed in the first row R1 and a second column C2 of the pixel matrix may be defined as one pixel pair. The first pixel Pr disposed in the first row R1 and the first column C1 of the pixel matrix may be connected to a first data line DL1, and the third pixel Pg disposed in the first row R1 and the second column C2 of the pixel matrix may be connected to a second data line DL2.

Pixels P located in the same column may be connected to the same data line DL. The one pixel pair may include one pixel P connected to the first gate line GWL1, and another pixel P connected to the second gate line GWL2. In an embodiment, for example, pixels arranged in odd columns C1, C3, C5, and C7, i.e., first pixels Pr and second pixels Pb, among the pixels P located in a same row, may be connected to the first gate line GWL1, and pixels arranged in even columns C2, C4, C6, and C8, i.e., third pixels Pg, among them may be connected to the second gate line GWL2. The pixels Pr and Pb connected to the first gate line GWL1 and the pixels Pg connected to the second gate line GWL2 may be arranged alternately in the first direction (x direction).

The data distribution circuit 170 may include a plurality of demultiplexers DMX. Each of the plurality of demultiplexers DMX may selectively connect one output line OL to a pair of an odd-numbered line and an even-numbered data line. Each of the plurality of demultiplexers DMX may include a first switch SW1 connected to a first control signal line SGL1 and a second switch SW2 connected to a second control signal line SGL2. The first switch SW1 may be disposed between the output line OL and the odd-numbered data line, and the second switch SW2 may be disposed between the output line OL and the even-numbered data line. Although an embodiment where the first switch SW1 and the second switch SW2 are P-channel transistors is shown in FIG. 4A, embodiments are not limited thereto. According to another embodiment, the first switch SW1 and the second switch SW2 may be N-channel transistors.

A first demultiplexer DMX may selectively connect a first output line OL1 to either the first data line DL1 or the second data line DL2, a second demultiplexer DMX may selectively connect a second output line OL2 to either a third data line DL3 or a fourth data line DL4, a third demultiplexer DMX may selectively connect a third output line OL3 to either a fifth data line DL5 or a sixth data line DL6, and a fourth demultiplexer DMX may selectively connect a fourth output line OL4 to either a seventh data line DL7 or an eighth data line DL8.

The first switch SW1 may be disposed between the first output line OL1 and the first data line DL1, the first switch SW1 may be disposed between the second output line OL2 and the third data line DL3, the first switch SW1 may be disposed between the third output line OL3 and the fifth data line DL5, and the first switch SW1 may be disposed between the fourth output line OL4 and the seventh data line DL7. The second switch SW2 may be disposed between the first output line OL1 and the second data line DL2, the second switch SW2 may be disposed between the second output line OL2 and the fourth data line DL4, the second switch SW2 may be disposed between the third output line OL3 and the sixth data line DL6, and the second switch SW2 may be disposed between the fourth output line OL4 and the eighth data line DL8.

The distribution control signal CCS may include a first control signal CLA and a second control signal CLB. A gate of each of the first switches SW1 may receive the first control signal CLA through the first control signal line SGL1, and a gate of each of the second switches SW2 may receive the second control signal CLB through the second control signal line SGL2. The first control signal CLA and the second control signal CLB may be applied at different timings not to overlap each other.

In an embodiment, for example, as illustrated in FIG. 4B, one frame 1F may include a first sub-frame period 1SF and a second sub-frame period 2SF. The first sub-frame period 1SF may be a period for writing data voltages to pixels P connected to the first gate lines GWL1, and the second sub-frame period 2SF may be a period for writing data voltages to pixels P connected to the second gate lines GWL2. According to an embodiment, the first sub-frame period 1SF may be a period for writing data voltages to first pixels Pr and second pixels Pb arranged in an odd-numbered column, and the second sub-frame period 2SF may be a period for writing data voltages to third pixels Pg arranged in an even-numbered column.

The first control signal CLA may be supplied as a square wave signal in which an on-voltage for turning on the first switches SW1 and an off-voltage for turning off the first switches SW1 are repeatedly output during a first sub-frame period. The first control signal CLA may be maintained at an off voltage during a second sub-frame period. The second control signal CLB may be maintained at an off voltage during the first sub-frame period. The second control signal CLB may be supplied as a square wave signal in which an on-voltage for turning on the second switches SW2 and an off-voltage for turning off the second switches SW2 are repeatedly output during the second sub-frame period. According to an embodiment, the on voltage of the first control signal CLA and the second control signal CLB may be low-level voltage (first-level voltage), and the off voltage thereof may be high-level voltage (second-level voltage).

In response to the first control signal CLA, the first switches SW1 may connect the first output line OL1 to the first data line DL1, connect the second output line OL2 to the third data line DL3, connect the third output line OL3 to the fifth data line DL5, and connect the fourth output line OL4 to the seventh data line DL7. In response to the first control signal CLA, the data distribution circuit 170 may apply a data voltage DATA[1] applied to the first output line OL1 to the first data line DL1, apply a data voltage DATA[2] applied to the second output line OL2 to the third data line DL3, apply a data voltage DATA[3] applied to the third output line OL3 to the fifth data line DL5, and apply a data voltage DATA[4] applied to the fourth output line OL4 to the seventh data line DL7.

In response to the second control signal CLB, the second switches SW2 may connect the first output line OL1 to the second data line DL2, connect the second output line OL2 to the fourth data line DL4, connect the third output line OL3 to the sixth data line DL6, and connect the fourth output line OL4 to the eighth data line DL8. In response to the second control signal CLB, the data distribution circuit 170 may apply the data voltage DATA[1] applied to the first output line OL1 to the second data line DL2, apply the data voltage DATA[2] applied to the second output line OL2 to the fourth data line DL4, apply the data voltage DATA[3] applied to the third output line OL3 to the sixth data line DL6, and apply the data voltage DATA[4] applied to the fourth output line OL4 to the eighth data line DL8.

During the first sub-frame period 1SF, first gate signals GW1(1), GW1(2), GW1(3), and GW1(4) may be sequentially supplied from the first gate driver 120 of FIG. 2 through first gate lines GWL1_1, GWL1_2, GWL1_3, and GWL1_4. The first gate signals GW1(1), GW1(2), GW1(3), and GW1(4) may be data write gate signals GW of FIGS. 3A and 3B that control turning on and turning off of data write transistors (e.g., the second transistors T2 of FIGS. 3A and 3B) of the first pixels Pr and the second pixels Pb arranged in the odd-numbered column.

The first gate driver 120 may output the first gate signals GW1(1), GW1(2), GW1(3), and GW1(4) in synchronization with output timing of the first control signal CLA. The first gate signals GW1(1), GW1(2), GW1(3), and GW1(4) being output in synchronization with the output timing of the first control signal CLA refers to a period during which an on voltage of the first control signal CLA is maintained (hereinafter, referred to as an “on voltage period”) overlapping with an on voltage period of each of the first gate signals GW1(1), GW1(2), GW1(3), and GW1(4). A first on voltage period of the first control signal CLA may overlap an on-voltage period of a first first gate signal (hereinafter, will be referred to as “1-1 gate signal”) GW1(1), a second on voltage period of the first control signal CLA may overlap an on-voltage period of a second first gate signal (hereinafter, will be referred to as “1-2 gate signal”) GW1(2), a third on voltage period of the first control signal CLA may overlap an on-voltage period of a third first gate signal (hereinafter, will be referred to as “1-3 gate signal”) GW1(3), and a fourth on-voltage period of the first control signal CLA may overlap an on voltage period of a fourth first gate signal (hereinafter, will be referred to as “1-4 gate signal”) GW1(4).

During the second sub-frame period 2SF, second gate signals GW2(1), GW2(2), GW2(3), and GW2(4) may be sequentially supplied from the second gate driver 130 of FIG. 2 through second gate lines GWL2_1, GWL2_2, GWL2_3, and GWL2_4. The second gate signals GW2(1), GW2(2), GW2(3), and GW2(4) may be data write gate signals GW for controlling turning on and turning off of data write transistors (e.g., the second transistors T2) of pixels Pg arranged in an even-numbered column.

The second gate driver 130 may output the second gate signals GW2(1), GW2(2), GW2(3), and GW2(4) in synchronization with output timing of the second control signal CLB. A first on voltage period of the second control signal CLB may overlap an on-voltage period of a first second gate signal (hereinafter, will be referred to as “2-1 gate signal”) GW2(1), a second on voltage period of the second control signal CLB may overlap an on-voltage period of a second second gate signal (hereinafter, will be referred to as “2-2 gate signal”) GW2(2), a third on voltage period of the second control signal CLB may overlap an on-voltage period of a third second gate signal (hereinafter, will be referred to as “2-3 gate signal”) GW2 (3), and a fourth on-voltage period of the second control signal CLB may overlap an on voltage period of a fourth second gate signal (hereinafter, will be referred to as “2-4 gate signal”) GW2(4).

During the first sub-frame period 1SF, the first control signal CLA may be supplied to the first switches SW1 of the demultiplexers DMX, and data voltages DATA[1], DATA[2], DATA[3], and DATA[4] may be supplied to pixels selected by the first gate signals GW1(1), GW1(2), GW1(3), and GW1(4). The data driver 150 of FIG. 2 may alternately output a first color data voltage and a second color data voltage to each of the first, second, third, and fourth output lines OL1, OL2, OL3, and OL4 in synchronization with the output timings of the first gate signals GW1(1), GW1(2), GW1(3), and GW1(4) during the first sub-frame period 1SF. The first color data voltage may be a data voltage applied to a first pixel Pr that emits light in a first color, and the second color data voltage may be a data voltage applied to a second pixel Pb that emits light in a second color.

In an embodiment, for example, pixels connected to the 1-1 gate line GWL1_1 may be selected (or activated) during the on-voltage period of the 1-1 gate signal GW1(1), and the data driver 150 may output data voltages R11, B13, R15, and B17 to the output lines OL1, OL2, OL3, and OL4. Pixels connected to the 1-2 gate line GWL1_2 may be selected during the on-voltage period of the 1-2 gate signal GW1(2), and the data driver 150 may output data voltages B21, R23, B25, and R27 to the output lines OL1, OL2, OL3, and OL4. Pixels connected to the 1-3 gate line GWL1_3 may be selected during the on-voltage period of the 1-3 gate signal GW1(3), and the data driver 150 may output data voltages R31, B33, R35, and B37 to the output lines OL1, OL2, OL3, and OL4. Pixels connected to the 1-4 gate line GWL1_4 may be selected during the on-voltage period of the 1-4 gate signal GW1(4), and the data driver 150 may output data voltages B41, R43, B45, and R47 to the output lines OL1, OL2, OL3, and OL4.

During the second sub-frame period 2SF, the second control signal CLB may be supplied to the second switches SW2 of the demultiplexers DMX, and data voltages DATA[1], DATA[2], DATA[3], and DATA[4] may be supplied to pixels selected by the second gate signals GW2(1), GW2(2), GW2(3), and GW2(4). The data driver 150 may output a third color data voltage to each of the first, second, third, and fourth output lines OL1, OL2, OL3, and OL4 in synchronization with the output timings of the second gate signals GW2(1), GW2(2), GW2(3), and GW2(4) during the second sub-frame period 2SF. The third color data voltage may be a data voltage applied to a third pixel Pg that emits light in a third color.

In an embodiment, for example, pixels connected to the 2-1 gate line GWL2_1 may be selected during the on-voltage period of the 2-1 gate signal GW2(1), and the data driver 150 may output data voltages G12, G14, G16, and G18 to the output lines OL1, OL2, OL3, and OL4. Pixels connected to the 2-2 gate line GWL2_2 may be selected during the on-voltage period of the 2-2 gate signal GW2(2), and the data driver 150 may output data voltages G22, G24, G26, and G28 to the output lines OL1, OL2, OL3, and OL4. Pixels connected to the 2-3 gate line GWL2_3 may be selected during the on-voltage period of the 2-3 gate signal GW2(3), and the data driver 150 may output data voltages G32, G34, G36, and G38 to the output lines OL1, OL2, OL3, and OL4. Pixels connected to the 2-4 gate line GWL2_4 may be selected during the on-voltage period of the 2-4 gate signal GW2(4), and the data driver 150 may output data voltages G42, G44, G46, and G48 to the output lines OL1, OL2, OL3, and OL4.

In an embodiment, a data voltage may be written to all of the pixels P of the pixel unit 110 during one frame 1F by using the above-described method. The data voltage DATA[1] supplied by the data driver 150 to the first output line OL1 may correspond to an order of R11, B21, R31, B41, G12, G22, G32, and G42, the data voltage DATA[2] supplied by the data driver 150 to the second output line OL2 may correspond to an order of B13, R23, B33, R43, G14, G24, G26, and G28, the data voltage DATA[3] supplied by the data driver 150 to the third output line OL3 may correspond to an order of R15, B25, R35, B45, G16, G26, G36, and G46, and the data voltage DATA[3] supplied by the data driver 150 to the fourth output line OL4 may correspond to an order of R17, B27, R37, B47, G18, G28, G38, and G48. That is, the data driver 150 may alternately output the first color data voltage and the second color data voltage during the first sub-frame period 1SF, and may output the third color data voltage during the second sub-frame period 2SF.

Referring to FIG. 5A, during the first sub-frame period 1SF, the data driver 150 may alternately output a first color data voltage R and a second color data voltage B to one output line OL. In an embodiment, for example, when the display device 10 displays white, the first color data voltage R of an on voltage and the second color data voltage B of an on voltage may be alternately output to an output line OL during the first sub-frame period 1SF. When the display device 10 displays red, the first color data voltage R of an on voltage and the second color data voltage B of an off voltage may be alternately output to the output line OL during the first sub-frame period 1SF. When the display device 10 displays blue, the first color data voltage R of an off voltage and the second color data voltage B of an on voltage may be alternately output to the output line OL during the first sub-frame period 1SF. When the display device 10 displays green, the first color data voltage R of an off voltage and the second color data voltage B of an off voltage may be alternately output to the output line OL during the first sub-frame period 1SF.

Referring to FIG. 5B, during the second sub-frame period 2SF, the data driver 150 may output a third color data voltage G to one output line OL. In an embodiment, for example, when the display device 10 displays white, the third color data voltage G of an on voltage may be repeatedly output to an output line OL during the second sub-frame period 2SF. When the display device 10 displays red, the third color data voltage G of an off voltage may be repeatedly output to the output line OL during the second sub-frame period 2SF. When the display device 10 displays blue, the third color data voltage G of an off voltage may be repeatedly output to the output line OL during the second sub-frame period 2SF. When the display device 10 displays green, the third color data voltage G of an on voltage may be repeatedly output to the output line OL during the second sub-frame period 2SF.

In a comparative example, when pixels arranged in a same row are connected to only one of a first gate line or a second gate line, a data voltage is output in a way such that a first color data voltage, a second color data voltage, and a third color data voltage alternate with each other. Respective gamma voltages of the first color data voltage, the second color data voltage, and the third color data voltage may be different from each other, thereby being changed every time the first color data voltage, the second color data voltage, and the third color data voltage are output alternately. Therefore, power consumption of a display device may increase due to toggling of the data voltage.

The display device 10 according to an embodiment may time-multiplex a period in which a first color data voltage and a second color data voltage are output and a period in which a third color data voltage is output by connecting first pixels Pr and second pixels Pb connected to odd-numbered data lines to the first gate lines GWL1 and connecting third pixels Pg connected to even-numbered data lines to the second gate lines GWL2. Accordingly, the number of changes in the gamma voltages may be reduced, and the display device 10 with reduced power consumption by reducing toggling of the data voltage may be implemented.

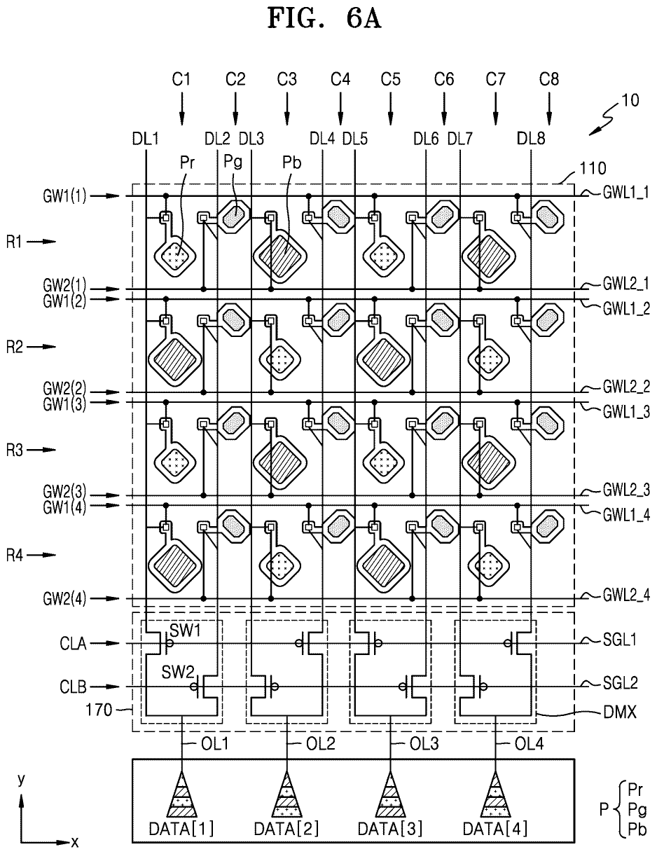

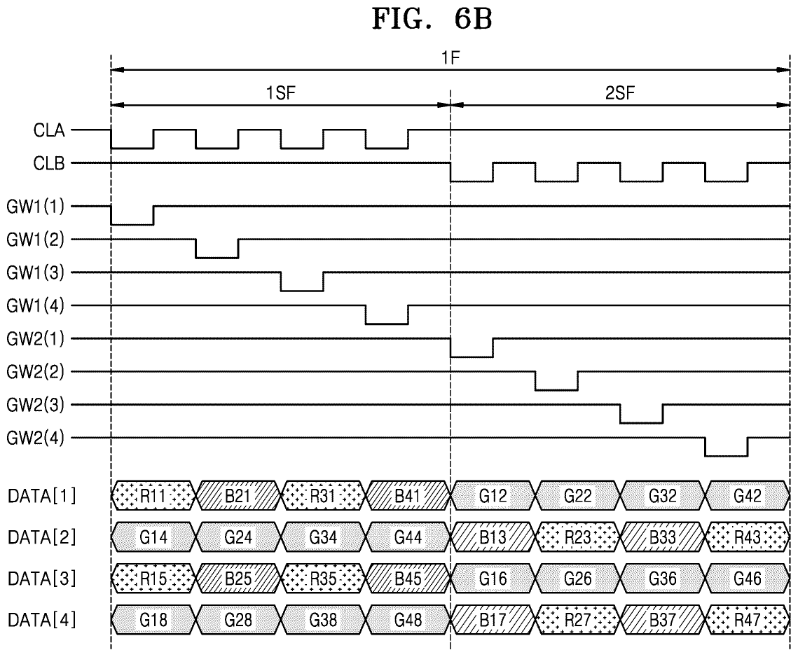

FIG. 6A is a schematic drawing for explaining respective operations of a pixel unit 110 and a data distribution circuit 170 according to an embodiment, and FIG. 6B is a signal timing diagram for schematically explaining an operation of the display device 10.

Referring to FIGS. 6A and 6B, an embodiment of the display device 10 may include the pixel unit 110 and the data distribution circuit 170. The pixel unit 110 may be included in the display area DA of FIG. 1A, and the data distribution circuit 170 may be included in the peripheral area PA of FIG. 1A.

The pixel unit 110 may include a plurality of pixels P connected to a plurality of gate lines, namely, first and second gate lines GWL1 and GWL2, and a plurality of data lines DL. Although an embodiment where the plurality of pixels P are arranged in a PenTile™ configuration is shown in FIG. 6A, embodiments are not limited thereto.

Each of the plurality of pixels P may include a display element and a pixel circuit connected to the display element. For convenience of illustration and description, FIG. 6A illustrates each of a plurality of pixel P based on a display element. However, it may be understood that the first gate lines GWL1, the second gate lines GWL2, and the data lines DL are connected to respective pixel circuits of the plurality of pixel P.

The plurality of pixels P may be arranged in an n×m matrix form. Here, n and m are natural numbers equal to or greater than 1. FIG. 6A illustrates that the plurality of pixels P are arranged in a 4×8 matrix form. However, embodiments are not limited thereto. The plurality of pixels P may include first pixels Pr that emit light in a first color, second pixels Pb that emit light in a second color, and third pixels Pg that emit light in a third color. The first color, the second color, and the third color may be red, blue and green, respectively. In odd columns of a pixel matrix, first pixels Pr and second pixels Pb may be arranged alternately in the second direction (y direction). In even columns, second pixels Pb may be arranged repeatedly in the second direction (y direction). Two pixels P adjacent to each other and arranged in a same row may be defined as one pixel pair. The two pixels P included in one pixel pair may be respectively connected to two data lines DL connected to the same output line OL.

Pixels P located in a same column may be connected to a same data line DL. The one pixel pair may include one pixel P connected to the first gate line GWL1, and another pixel P connected to the second gate line GWL2. In an embodiment, for example, among pixels P located in the same row, pixels P belonging to an odd-numbered pixel pair and arranged in odd-numbered columns C1 and C5 and pixels P belonging to an even-numbered pixel pair and arranged in even-numbered columns C4 and C8 may be connected to a first gate line GWL1. Among the pixels P located in the same row, pixels P belonging to an odd-numbered pixel pair and arranged in even-numbered columns C2 and C6 and pixels P belonging to an even-numbered pixel pair and arranged in odd-numbered columns C3 and C7 may be connected to a second gate line GWL2.

The data distribution circuit 170 may include a plurality of demultiplexers DMX. Each of the plurality of demultiplexers DMX may selectively connect one output line OL to one of two data lines. Each of the plurality of demultiplexers DMX may include a first switch SW1 connected to a first control signal line SGL1 and a second switch SW2 connected to a second control signal line SGL2. The first switch SW1 may be disposed between odd-numbered output lines OL1 and OL3 and odd-numbered data lines DL1 and DL5 and between even-numbered output lines OL2 and OL4 and even-numbered data lines DL4 and DL8. The second switch SW2 may be disposed between the odd-numbered output lines OL1 and OL3 and even-numbered data lines DL2 and DL6 and between the even-numbered output lines OL2 and OL4 and odd-numbered data lines DL3 and DL7.

A first demultiplexer DMX may selectively connect a first output line OL1 to either a first data line DL1 or a second data line DL2, a second demultiplexer DMX may selectively connect a second output line OL2 to either a third data line DL3 or a fourth data line DL4, a third demultiplexer DMX may selectively connect a third output line OL3 to either a fifth data line DL5 or a sixth data line DL6, and a fourth demultiplexer DMX may selectively connect a fourth output line OL4 to either a seventh data line DL7 or an eighth data line DL8.

The distribution control signal CCS may include a first control signal CLA and a second control signal CLB. A gate of each of the first switches SW1 may receive the first control signal CLA through the first control signal line SGL1, and a gate of each of the second switches SW2 may receive the second control signal CLB through the second control signal line SGL2. The first control signal CLA and the second control signal CLB may be applied at different timings not to overlap each other.

In an embodiment, for example, as illustrated in FIG. 6B, one frame 1F may include a first sub-frame period 1SF and a second sub-frame period 2SF. The first sub-frame period 1SF may be a period for writing data voltages to pixels P connected to the first gate lines GWL1, and the second sub-frame period 2SF may be a period for writing data voltages to pixels P connected to the second gate lines GWL2.

The first control signal CLA may be supplied as a square wave signal in which an on-voltage for turning on the first switches SW1 and an off-voltage for turning off the first switches SW1 are repeatedly output during a first sub-frame period. The first control signal CLA may be maintained at an off voltage during a second sub-frame period. The second control signal CLB may be maintained at an off voltage during a first sub-frame period. The second control signal CLB may be supplied as a square wave signal in which an on-voltage for turning on the second switches SW2 and an off-voltage for turning off the second switches SW2 are repeatedly output during a second sub-frame period. According to an embodiment, the on voltage of the first control signal CLA and the second control signal CLB may be low-level voltage (first-level voltage), and the off voltage thereof may be high-level voltage (second-level voltage).

In response to the first control signal CLA, the first switches SW1 may connect the first output line OL1 to the first data line DL1, connect the second output line OL2 to the fourth data line DL4, connect the third output line OL3 to the fifth data line DL5, and connect the fourth output line OL4 to the eighth data line DL8. In response to the first control signal CLA, the data distribution circuit 170 may apply a data voltage DATA[1] applied to the first output line OL1 to the first data line DL1, apply a data voltage DATA[2] applied to the second output line OL2 to the fourth data line DL4, apply a data voltage DATA[3] applied to the third output line OL3 to the fifth data line DL5, and apply a data voltage DATA[4] applied to the fourth output line OL4 to the eighth data line DL8.

In response to the second control signal CLB, the second switches SW2 may connect the first output line OL1 to the second data line DL2, connect the second output line OL2 to the third data line DL3, connect the third output line OL3 to the sixth data line DL6, and connect the fourth output line OL4 to the seventh data line DL7. In response to the second control signal CLB, the data distribution circuit 170 may apply the data voltage DATA[1] applied to the first output line OL1 to the second data line DL2, apply the data voltage DATA[2] applied to the second output line OL2 to the third data line DL3, apply the data voltage DATA[3] applied to the third output line OL3 to the sixth data line DL6, and apply the data voltage DATA[4] applied to the fourth output line OL4 to the seventh data line DL7.

During the first sub-frame period 1SF, first gate signals GW1(1), GW1(2), GW1(3), and GW1(4) may be sequentially supplied from the first gate driver 120 of FIG. 2 through first gate lines GWL1_1, GWL1_2, GWL1_3, and GWL1_4. The first gate signals GW1(1), GW1(2), GW1(3), and GW1(4) may be data write gate signals GW of FIGS. 3A and 3B that control turning on and turning off of data write transistors (e.g., the second transistors T2 of FIGS. 3A and 3B) of which gates are connected to the first gate line GWL1.

The first gate driver 120 may output the first gate signals GW1(1), GW1(2), GW1(3), and GW1(4) in synchronization with output timing of the first control signal CLA. A first on voltage period of the first control signal CLA may overlap an on-voltage period of a 1-1 gate signal GW1(1), a second on voltage period of the first control signal CLA may overlap an on-voltage period of a 1-2 gate signal GW1(2), a third on voltage period of the first control signal CLA may overlap an on-voltage period of a 1-3 gate signal GW1(3), and a fourth on-voltage period of the first control signal CLA may overlap an on voltage period of a 1-4 gate signal GW1(4).

During the second sub-frame period 2SF, second gate signals GW2(1), GW2(2), GW2(3), and GW2(4) may be sequentially supplied from the second gate driver 130 of FIG. 2 through second gate lines GWL2_1, GWL2_2, GWL2_3, and GWL2_4. The second gate signals GW2(1), GW2(2), GW2(3), and GW2(4) may be data write gate signals GW for controlling turning on and turning off of data write transistors (e.g., the second transistors T2) of which gates are connected to the second gate line GWL2.

The second gate driver 130 may output the second gate signals GW2(1), GW2(2), GW2(3), and GW2(4) in synchronization with output timing of the second control signal CLB. A first on voltage period of the second control signal CLB may overlap an on-voltage period of a 2-1 gate signal GW2(1), a second on voltage period of the second control signal CLB may overlap an on-voltage period of a 2-2 gate signal GW2(2), a third on voltage period of the second control signal CLB may overlap an on-voltage period of a 2-3 gate signal GW2(3), and a fourth on-voltage period of the second control signal CLB may overlap an on voltage period of a 2-4 gate signal GW2(4).

During the first sub-frame period 1SF, the first control signal CLA may be supplied to the first switches SW1 of the demultiplexers DMX, and data voltages DATA[1], DATA[2], DATA[3], and DATA[4] may be supplied to pixels selected by the first gate signals GW1(1), GW1(2), GW1(3), and GW1(4). The data driver 150 of FIG. 2 may output a data voltage to each of the first, second, third, and fourth output lines OL1, OL2, OL3, and OL4 in synchronization with the output timings of the first gate signals GW1(1), GW1(2), GW1(3), and GW1(4) during the first sub-frame period 1SF.

During the first sub-frame period 1SF, the data driver 150 may alternately output the first color data voltage and the second color data voltage to the odd-numbered output lines OL1 and OL3, and may output the third color data voltage to the even-numbered output lines OL2 and OL4. In an embodiment, for example, pixels connected to the 1-1 gate line GWL1_1 may be selected (or activated) during the on-voltage period of the 1-1 gate signal GW1(1), and the data driver 150 may output data voltages R11, G14, R15, and G18 to the output lines OL1, OL2, OL3, and OL4. Pixels connected to the 1-2 gate line GWL1_2 may be selected during the on-voltage period of the 1-2 gate signal GW1(2), and the data driver 150 may output data voltages B21, G24, B25, and G28 to the output lines OL1, OL2, OL3, and OL4. Pixels connected to the 1-3 gate line GWL1_3 may be selected during the on-voltage period of the 1-3 gate signal GW1(3), and the data driver 150 may output data voltages R31, G34, R 35, and G38 to the output lines OL1, OL2, OL3, and OL4. Pixels connected to the 1-4 gate line GWL1_4 may be selected during the on-voltage period of the 1-4 gate signal GW1(4), and the data driver 150 may output data voltages B41, G44, B45, and G48 to the output lines OL1, OL2, OL3, and OL4. Therefore, during the first sub-frame period 1SF, the pixel unit 110 may display all of the first color, the second color, and the third color.

During the second sub-frame period 2SF, the second control signal CLB may be supplied to the second switches SW2 of the demultiplexers DMX, and data voltages DATA[1], DATA[2], DATA[3], and DATA[4] may be supplied to pixels selected by the second gate signals GW2(1), GW2(2), GW2(3), and GW2(4). The data driver 150 may output a data voltage corresponding to each of the first, second, third, and fourth output lines OL1, OL2, OL3, and OL4 in synchronization with the output timings of the second gate signals GW2(1), GW2(2), GW2(3), and GW2(4) during the second sub-frame period 2SF.

During the first sub-frame period 1SF, the data driver 150 may output the third color data voltage to the odd-numbered output lines OL1 and OL3, and may alternately output the first color data voltage and the second color data voltage to the even-numbered output lines OL2 and OL4. In an embodiment, for example, pixels connected to the 2-1 gate line GWL2_1 may be selected during the on-voltage period of the 2-1 gate signal GW2(1), and the data driver 150 may output data voltages G12, B13, G16, and B17 to the output lines OL1, OL2, OL3, and OL4. Pixels connected to the 2-2 gate line GWL2_2 may be selected during the on-voltage period of the 2-2 gate signal GW2(2), and the data driver 150 may output data voltages G22, R23, G26, and R27 to the output lines OL1, OL2, OL3, and OL4. Pixels connected to the 2-3 gate line GWL2_3 may be selected during the on-voltage period of the 2-3 gate signal GW2(3), and the data driver 150 may output data voltages G32, B33, G36, and B37 to the output lines OL1, OL2, OL3, and OL4. Pixels connected to the 2-4 gate line GWL2_4 may be selected during the on-voltage period of the 2-4 gate signal GW2(4), and the data driver 150 may output data voltages G42, R43, G46, and R47 to the output lines OL1, OL2, OL3, and OL4. Therefore, during the second sub-frame period 2SF, the pixel unit 110 may display all of the first color, the second color, and the third color.

In such an embodiment, a data voltage may be written to all of the pixels P of the pixel unit 110 during one frame 1F by using the above-described method. The data voltage DATA[1] supplied by the data driver 150 to the first output line OL1 may correspond to an order of R11, B21, R31, B41, G12, G22, G32, and G42, the data voltage DATA[2] supplied by the data driver 150 to the second output line OL2 may correspond to an order of G14, G24, G26, G28, B13, R23, B33, and R43, the data voltage DATA[3] supplied by the data driver 150 to the third output line OL3 may correspond to an order of R15, B25, R35, B45, G16, G26, G36, and G46, and the data voltage DATA[3] supplied by the data driver 150 to the fourth output line OL4 may correspond to an order of G18, G28, G38, G48, R17, B27, R37, and B47. During each sub-frame period, the pixel unit 110 may display all of the first color, the second color, and the third color. Accordingly, the display device 10 may display a high-quality image in which a color break up phenomenon in which colors appear separated is reduced.

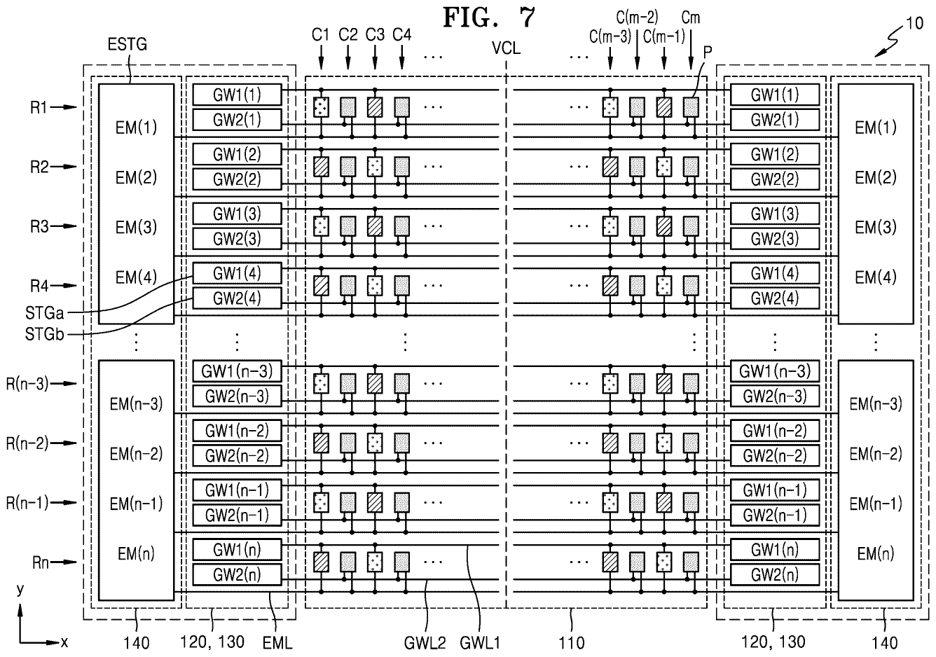

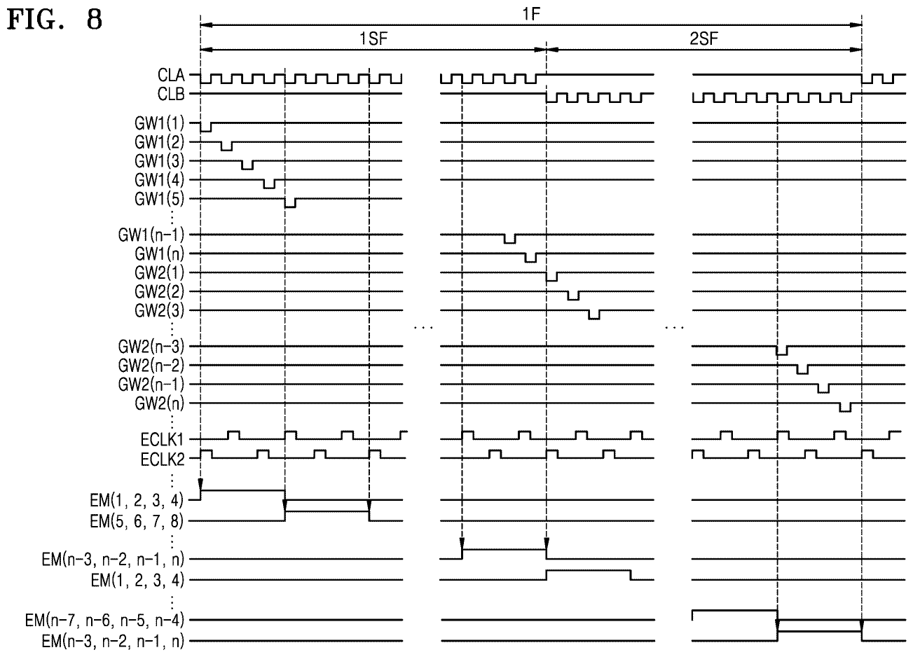

FIG. 7 is a schematic drawing of the display device 10 according to an embodiment, and FIG. 8 is a signal timing diagram for schematically explaining an operation of the display device 10 illustrated in FIG. 7.

Referring to FIGS. 7 and 8, an embodiment of the display device 10 may include the pixel unit 110, the first gate driver 120, the second gate driver 130, and the light-emission control driver 140. The pixel unit 110 may be included in the display area DA, and the first gate driver 120, the second gate driver 130, and the light-emission control driver 140 may be included in the peripheral area PA. According to an embodiment, each of the first gate driver 120, the second gate driver 130, and the light-emission control driver 140 may be provided in two and may be arranged on respective sides of the display area DA with the display area DA therebetween.

Pixels arranged on a left side (−x direction) of an imaginary center line VCL that bisects the display area DA may be connected to the first gate driver 120, the second gate driver 130, and the light-emission control driver 140 located on the left side (−x direction). Pixels arranged on a right side (+x direction) of the imaginary center line VCL that bisects the display area DA may be connected to the first gate driver 120, the second gate driver 130, and the light-emission control driver 140 located on the right side (+x direction). According to another embodiment, the first gate driver 120, the second gate driver 130, and the light-emission control driver 140 may each be arranged on only one side of the peripheral area PA.

The pixel unit 110 may include a plurality of pixels P connected to a plurality of gate lines, namely, first and second gate lines GWL1 and GWL2, and light-emission control lines EML. The plurality of pixels P may be arranged in an n×m matrix form. Here, n and m are natural numbers equal to or greater than 1. The plurality of pixels P may include first pixels that emit light in a first color, second pixels that emit light in a second color, and third pixels that emit light in a third color. The first color, the second color, and the third color may be different colors. For example, the first color, the second color, and the third color may be red, blue and green, respectively.

Two pixels P adjacent to each other and arranged in a same row may be defined as one pixel pair. The one pixel pair may include one pixel P connected to the first gate line GWL1, and another pixel P connected to the second gate line GWL2. According to an embodiment, as described above with reference to FIG. 4A, pixels P located in odd-numbered columns among pixels P located in the same row may be connected to the same first gate line GWL1. Pixels P located in even-numbered columns among the pixels P located in a same row may be connected to a same second gate line GWL2. In an embodiment, for example, among pixels P located in an i-th row, the pixels P located in odd-numbered columns C1, C3, . . . , and Cm-1 may be connected to an i-th first gate line GWL1, and among the pixels P located in the i-th row, pixels P located in even-numbered columns C2, C4, . . . , and Cm may be connected to an i-th second gate line GWL2. The pixels P located in the same row may be connected to the same light-emission control line EML. In an embodiment, for example, the pixels P located in the i-th row may be connected to an i-th light-emission control line EML. Here, i is a natural number greater than or equal to 1 and less than or equal to n.

The first gate driver 120 includes n first gate stages STGa that shift and output the first gate signals GW1. An i-th first gate stages STGa may be connected to an i-th first gate line GWL1. In such an embodiment, n first gate stages STGa may be dependently (e.g., cascadedly) connected to each other.

The second gate driver 130 includes n second gate stages STGb that shift and output the second gate signals GW2. An i-th second gate stages STGb may be connected to an i-th second gate line GWL2. In such an embodiment, n second gate stages STGb may be dependently (e.g., cascadedly) connected to each other.

The light-emission control driver 140 may include n/4 light-emission control stages ESTG that shift and output light-emission control signals EM. One light-emission control stage ESTG may be connected to four light-emission control lines EML to apply the same light-emission control signal EM to the four light-emission control lines EML. That is, an i-th light-emission control stage ESTG may be connected to a (4i-3)-th light-emission control line EML, a (4i-2)-th light-emission control line EML, a (4i-1)-th light-emission control line EML, and a 4i-th light-emission control line EML. The number of light-emission control stages ESTG may be one-quarter of the number of pixel rows. In such an embodiment, n/4 light-emission control stage ESTG may be dependently (e.g., cascadedly) connected to each other.

Each light-emission control stage ESTG may receive an output signal of a previous stage and a first light-emission control clock signal ECLK1 and/or a second light-emission control clock signal ECLK2 and output a light-emission control signal EM. A first light-emission control stage, of which no previous stage exist, may receive a separate start signal. The second light-emission control clock signal ECLK2 may have a same waveform as the first light-emission control clock signal ECLK1, and may be applied with a phase shifted (delayed) by a predetermined interval from the first light-emission control clock signal ECLK1.

In an embodiment, four light-emission control lines EML connected to one light-emission control stage ESTG may be defined as one light-emission control line group. A light-emission control signal EM output by one light-emission control stage ESTG may be output to a light-emission control line group connected to the light-emission control stage ESTG. In other words, the light-emission control driver 140 may group (or divide) the light-emission control lines EML into groups of four and sequentially output the light-emission control signals in units of groups or on a group-by-group basis.

Pixels P located in a same column may be connected to a same data line. In an embodiment, for example, pixels P located in a j-th column may be connected to a j-th data line. Here, j is a natural number greater than or equal to 1 and less than or equal to m. An odd-numbered data line and an even-numbered data line that are adjacent to each other may be selectively connected to one output line through the data distribution circuit 170 of FIG. 2. According to an embodiment, as described above with reference to FIG. 4A, the data distribution circuit 170 may connect output lines to odd-numbered data lines by the first control signal CLA, and a data voltage may be supplied from the data driver 150 of FIG. 2 to pixels P located in odd-numbered columns C1, C3, . . . , and Cm-1. The data distribution circuit 170 may connect output lines to even-numbered data lines by the second control signal CLB, and a data voltage may be supplied from the data driver 150 to pixels P located in even-numbered columns C2, C4, . . . , and Cm.

One frame 1F may include a first sub-frame period 1SF and a second sub-frame period 2SF. During the first sub-frame period 1SF, the first control signal CLA may be supplied as a square wave signal in which an on voltage and an off voltage are repeatedly output, and the second control signal CLB may be maintained as an off voltage. During the second sub-frame period 2SF, the first control signal CLA may be maintained as an off voltage, and the second control signal CLB may be supplied as a square wave signal in which an on voltage and an off voltage are repeatedly output.

During the first sub-frame period 1SF, the first gate driver 120 may sequentially output the first gate signal GW1 to each of the first gate lines GWL1 in synchronization with the output timing of the first control signal CLA. During the second sub-frame period 2SF, the second gate driver 130 may sequentially output the second gate signal GW2 to each of the second gate lines GWL2 in synchronization with the output timing of the second control signal CLB.

The light-emission control driver 140 may output light-emission control signals EM in synchronization with respective output timings of the first light-emission control clock signal ECLK1 and the second light-emission control clock signal ECLK2. Odd-numbered light-emission control signals EM may be transitioned to an on voltage level in synchronization with the output timing of (high voltage of) the second light-emission control clock signal ECLK2. Even-numbered light-emission control signals EM may be transitioned to an on voltage level in synchronization with the output timing of (high voltage of) the first light-emission control clock signal ECLK1. A timing at which a previous light-emission control signal EM reverses from an on voltage level to an off voltage level may be the same as a timing at which a subsequent emission control signal EM reverses from the off voltage level to the on voltage level.

In an embodiment, four light-emission control lines EML belonging to a same group may receive a same light-emission control signals EM. During the first sub-frame period 1SF, an on-voltage period of each light-emission control signal EM may overlap on-voltage periods of four consecutive first gate signals GW1. In an embodiment, for example, a first light-emission control signal EM(1, 2, 3, 4) of the first sub-frame period 1SF may be applied to first through fourth light-emission control lines simultaneously, and an on-voltage period of the first light-emission control signal EM(1, 2, 3, 4) may overlap an on-voltage period of a 1-1 gate signal GW1(1), an on-voltage period of a 1-2 gate signal GW1(2), an on-voltage period of a 1-3 gate signal GW1(3), and an on-voltage period of a 1-4 gate signal GW1(4).

The first gate driver 120 may operate once (with one cycle) so that data voltages are written to pixels P located in odd-numbered columns of all rows during the first sub-frame period 1SF. The first gate driver 120 operating once indicates sequentially outputting a first gate signal GW1 of an on voltage level once to the first gate lines GWL1. During the first sub-frame period 1SF, the light-emission control driver 140 may operate once. The light-emission control driver 140 operating once indicates sequentially outputting a light-emission control signal EM of an on voltage level once to the light-emission control lines EML.

During the second sub-frame period 2SF, an on-voltage period of each light-emission control signal EM may overlap on-voltage periods of four consecutive second gate signals GW2. In an embodiment, for example, a first light-emission control signal EM(1, 2, 3, 4) of the second sub-frame period 2SF may be applied to the first through fourth light-emission control lines simultaneously, and an on-voltage period of the first light-emission control signal EM(1, 2, 3, 4) may overlap an on-voltage period of a 2-1 gate signal GW2(1), an on-voltage period of a 2-2 gate signal GW2(2), an on-voltage period of a 2-3 gate signal GW2(3), and an on-voltage period of a 2-4 gate signal GW2(4).

The second gate driver 130 may operate once (with one cycle) so that data voltages are written to pixels P located in even-numbered columns of all rows during the second sub-frame period 2SF. The second gate driver 130 operating once indicates sequentially outputting a second gate signal GW2 of an on voltage level once to the second gate lines GWL2. During the second sub-frame period 2SF, the light-emission control driver 140 may operate once.

In such an embodiment, a data voltage may be written to all of the pixels P of the pixel unit 110 during one frame 1F by using the above-described method. During one frame 1F, the first gate driver 120 and the second gate driver 130 may each operate once, and the light-emission control driver 140 may operate twice.

When a light-emission control driver operates once during one frame, a frequency of a first light-emission control clock signal and a frequency of a second light-emission control clock signal may be defined as f_{REF}. In a comparative example, the light-emission control driver groups light-emission control lines into groups of two and outputs light-emission control signals in units of groups, such that the frequency of the first light-emission control clock signal and the frequency of the second light-emission control clock signal for enabling the light-emission control driver to operate twice during one frame may each be 2f_{REF}. On the other hand, according to an embodiment, the light-emission control driver 140 groups (or divides) the light-emission control lines EML into groups of four and outputs light-emission control signals EM in units of groups, such that the frequency of the first light-emission control clock signal ECLK1 and the frequency of the second light-emission control clock signal ECLK2 for enabling the light-emission control driver 140 to operate twice during one frame 1F may each be f_{REF}. That is, according to an embodiment, while the light-emission control driver 140 is operating twice during one frame 1F, the frequency of the first light-emission control clock signal ECLK1 and the frequency of the second light-emission control clock signal ECLK2 may be maintained to be the same as a frequency when the light-emission control driver operates once during one frame.

Embodiments of the display device 10 described above with reference to FIGS. 4A and 4B has been mainly described for convenience of illustration and description, but embodiments are not limited thereto. The light-emission control driver 140 that groups (or divides) the light-emission control lines into groups of four and outputs the light-emission control signals in units of groups is equally applicable to the display device 10 described above with reference to FIGS. 6A and 6B.

The display device 10 according to an embodiment may include the data driver 150 having a reduced number of output lines, leading to a reduction in manufacturing costs. In such an embodiment, a period in which a first color data voltage and a second color data voltage are output and a period in which a third color data voltage is output may be time-multiplexed, leading to an improvement in power consumption due to data voltage toggling. In such an embodiment, the light-emission control driver 140 may group (or divide) the light-emission control lines into groups of four and output light-emission control signals in units of groups, thereby reducing the power consumption for driving the light-emission control driver 140.

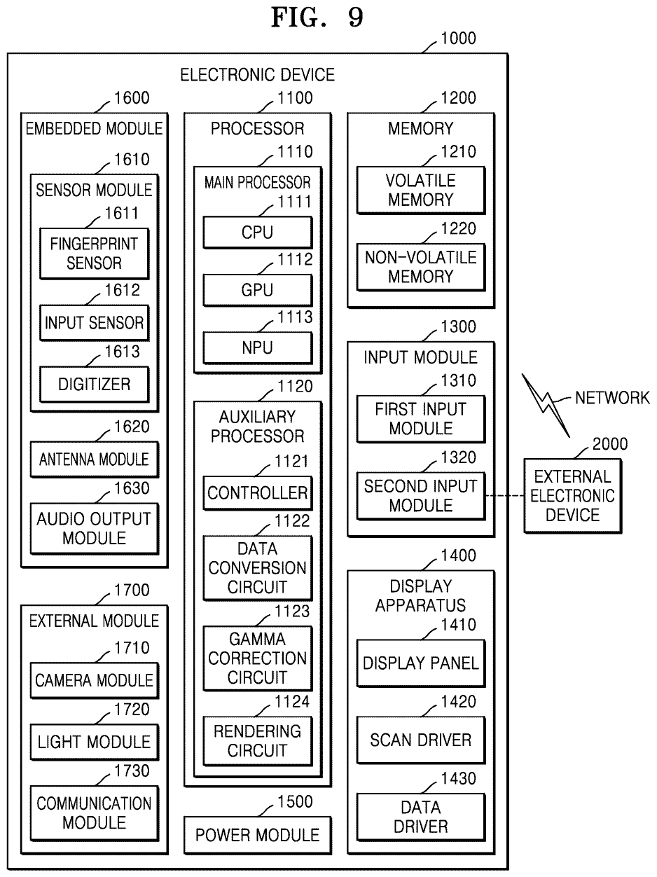

FIG. 9 is a schematic block diagram of an electronic device 1000 according to an embodiment.

An electronic device 1000 according to embodiments may display a video or a still image, and thus may be not only portable electronic devices (such as, mobile phones, smartphones, tablet personal computers (PCs), mobile communication terminals, electronic notebooks, electronic books, portable multimedia players (PMPs), navigation devices, and ultra mobile PCs (UMPCs)) but also various electronic devices (such as, televisions, notebooks, monitors, advertisement panels, and Internet of things (IoT) devices. The electronic device 1000 according to an embodiment may also be wearable devices, such as a smart watch, a watch phone, a glasses-type display, and a head mounted display (HMD). The electronic device 1000 according to an embodiment may be a dashboard of automobiles, a center information display (CID) of the center fasciae or dashboards of automobiles, a room mirror display that replaces the side mirrors of automobiles, and a user interface disposed on the rear sides of front seats to serve as an entertainment device for back seat passengers of automobiles.

Referring to FIG. 9, an embodiment of the electronic device 1000 may include a processor 1100, a memory 1200, an input module 1300, a display module 1400, a power module 1500, an internal module 1600, and an external module 1700. According to an embodiment, at least one of the above-described components of the electronic device 1000 may be omitted, or one or more other components may be added to the electronic device 1000. According to an embodiment, some of the above-described components (e.g., the internal module 1600) may be integrated into another component (e.g., the display module 1400).

The processor 1100 may execute software to control at least one other component (e.g., a hardware or software component) of the electronic device 1000 connected to the processor 1100, and may perform various data processing or computations. According to an embodiment, as at least portion of data processing or calculation, the processor 1100 may store a command or data received from another component (e.g., the input module 1300, a sensor module 1610, or a communication module 1730) in volatile memory 1210, process the command or data stored in the volatile memory 1210, and store resulting data in non-volatile memory 1220.

The processor 1100 may include a main processor 1110 and an auxiliary processor 1120. The main processor 1110 may include at least one selected from a central processing unit (CPU) and an application processor (AP). The main processor 1110 may further include at least one selected from a graphics processing unit (GPU), a communication processor (CP), and an image signal processor (ISP). The main processor 1110 may further include a neural processing unit (NPU) 1113. The NPU 1113 is a processor specialized in processing an artificial intelligence (AI) model, and the AI model may be created through machine learning. The AI model may include a plurality of artificial neural network layers. An artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the aforementioned networks, but is not limited to the above-described examples. The AI model may additionally or alternatively include a software structure in addition to a hardware structure. At least two selected from the aforementioned processing units and processors may be implemented as a single integrated configuration (e.g., a single chip) or may be implemented as independent configurations (e.g., a plurality of chips).

The auxiliary processor 1120 may include a controller 1121. The controller 1121 may include an interface conversion circuit and a timing control circuit. The controller 1121 receives an image signal from the main processor 1110, and converts a data format of the image signal according to interface specifications with the display module 1400 to thereby output image data. The controller 1121 may output various control signals necessary for driving the display module 1400.

The auxiliary processor 1120 may further include data processing circuits, such as a data conversion circuit 1122, a gamma correction circuit 1123, and a rendering circuit 1124. The data conversion circuit 1122 may receive the image data from the controller 1121, and may compensate for the image data so that an image is displayed with a desired brightness according to, for example, characteristics of the electronic device 1000 or a user's settings, or may convert the image data to perform, for example, power consumption reduction or afterimage compensation. The gamma correction circuit 1123 may convert image data, a gamma reference voltage, etc., so that an image displayed on the electronic device 1000 has desired gamma characteristics. The rendering circuit 1124 may receive the image data from the controller 1121, and may render the image data according to a pixel layout, etc. of a display panel 1410 that are applied to the electronic device 1000. At least one selected from the data conversion circuit 1122, the gamma correction circuit 1123, and the rendering circuit 1124 may be integrated into another component (e.g., the controller 1121).

The memory 1200 may store various data used by at least one component of the electronic device 1000 (e.g., the processor 1100 or the sensor module 1610) and input data or output data for commands associated with the various data. The memory 1200 may include at least one selected from the volatile memory 1210 and the non-volatile memory 1220.

The input module 1300 may receive commands or data that are to be used by components of the electronic device 1000 (e.g., the processor 1100, the sensor module 1610, or the audio output module 1630) from an external source of the electronic device 1000 (e.g., the user or an external electronic device 2000).

The input module 1300 may include a first input module 1310 to which a command or data is input by the user, and a second input module 1320 to which a command or data is input by the external electronic device 2000.

The first input module 1310 may include a microphone, a mouse, a keyboard, or a pen (e.g., a passive pen or an active pen). The first input module 1310 may include a mechanical input unit, such as a button, a dome switch, a jog wheel, and a jog switch each located on a rear or lateral surface of the electronic device 1000, or a touch input unit.

The second input module 1320 may be connected to various types of external electronic devices 2000 connected to the electronic device 1000 in a wired or wireless manner. According to an embodiment, the second input module 1320 may include a high definition multimedia interface (HDMI), a universal serial bus (USB) interface, a secure digital (SD) card interface, or an audio interface. The second input module 1320 may include a connector capable of physically connecting the electronic device 1000 to the external electronic device 2000, for example, an HDMI connector, a USB connector, an SD card connector, or an audio connector (e.g., a headphone connector). When the external electronic device 2000 is connected to the second input module 1320, the electronic device 1000 may perform an appropriate control related with the connected external electronic device 2000.

The display module 1400 visually provides information to the user. The display module 1400 may include a display panel 1410, a scan driver 1420, and a data driver 1430. The display module 1400 may further include a window, a chassis, a bracket, a supporter, a heat dissipation member, etc. to protect or support the display panel 1410.

The display panel 1410 displays (outputs) information that is processed by the electronic device 1000. The display panel 1410 may display execution screen information of an application being driven by the electronic device 1000, or may display user interface (UI) and graphical user interface (GUI) information based on the execution screen information. The display panel 1410 may include a liquid crystal display panel, an organic light-emitting display panel, or an inorganic light-emitting display panel, and the type of the display panel 1410 is not particularly limited. The display panel 1410 may be of a rigid type or a flexible type capable of rolling or folding.

The scan driver 1420 may be mounted as a driving chip on the display panel 1410. Alternatively, the scan driver 1420 may be directly formed on the display panel 1410. In an embodiment, for example, the scan driver 1420 may include an Amorphous Silicon TFT Gate (ASG) driver circuit, a Low Temperature Polycrystaline Silicon (LTPS) TFT gate driver circuit, or an Oxide Semiconductor TFT Gate (OSG) driver circuit embedded in the display panel 1410. The scan driver 1420 receives a control signal from the controller 1121 and outputs scan signals to the display panel 1410 in response to the control signal. The scan driver 1420 may include the first gate driver 120 of FIG. 2, and the second gate driver 130 of FIG. 2.

The display panel 1410 may further include the light-emission control driver 140 of FIG. 2. The light-emission control driver 140 outputs a light-emission control signal to the display panel 1410 in response to the control signal received from the controller 1121. The light-emission control driver 140 may be formed separately from the scan driver 1420 or may be integrated into the scan driver 1420.

The data driver 1430 receives a control signal from the controller 1121, convert image data into a data voltage in the form of an analog voltage in response to the control signal, and then output data voltages to the display panel 1410.

The power module 1500 supplies power to components of the electronic device 1000. In an embodiment, the power module 1500 may include a battery that charges a power supply voltage. The power module 1500 may also include a connection port, and the connection port may be included in the second input module 1320 to which an external charger supplying power to charge the battery is connected. Alternatively, the power module 1500 may include a wireless power transmission/reception member to charge the battery wirelessly. The wireless power transmission/reception member may include a plurality of coil-type antenna radiators. The power module 1500 may include a power management integrated circuit (PMIC). The PMIC provides optimized power to each of the components of the electronic device 1000.

The electronic device 1000 may further include an internal module 1600 and an external module 1700. The internal module 1600 may include a sensor module 1610, an antenna module 1620, and an audio output module 1630. The external module 1700 may include a camera module 1710, a light module 1720, and a communication module 1730.

The sensor module 1610 may detect an input from a user's body or a pen input and may generate an electric signal or data value corresponding to the input. The sensor module 1610 may include at least one selected from a fingerprint sensor 1611, an input sensor 1612, and a digitizer 1613.

The fingerprint sensor 1611 may generate a data value corresponding to the user's fingerprint. The fingerprint sensor 1611 may include either an optical type or capacitance type fingerprint sensor.

The input sensor 1612 may generate a data value corresponding to coordinate information of an input from a user's body or a pen input made by a pen. The input sensor 1612 generates, as the data value, a capacitance variation caused due to the input. The input sensor 1612 may detect an input made by a passive pen or may transmit and receive data to and from an active pen.

The input sensor 1612 may measure a biological signal, such as a blood pressure, moisture, or a body fat. In an embodiment, for example, when the user allows a part of his or her body to touch a sensor layer or sensing panel and does not move for a certain period of time, the input sensor 1612 may detect the biological signal, based on a change in an electric field caused by the part of his or her body, and output information desired by the user to the display module 1400.

The digitizer 1613 may generate a data value corresponding to coordinate information of the pen input. The digitizer 1613 generates, as the data value, an electromagnetic variation caused due to the input. The digitizer 1613 may detect an input made by a passive pen or may transmit and receive data to and from an active pen.

According to an embodiment, at least one selected from the fingerprint sensor 1611, the input sensor 1612, and the digitizer 1613 may be built in or integrated into the display panel 1410. In an embodiment, for example, at least one of the fingerprint sensor 1611, the input sensor 1612, and the digitizer 1613 may be formed via a process that is continuous with a process of forming the pixel circuits and light-emitting diodes of the display panel 1410. Accordingly, the display panel 1410 may function as one of input units for providing an input interface between the electronic device 1000 and the user, and simultaneously function as one of output units for providing an output interface between the electronic device 1000 and the user.

According to another embodiment, at least two of the fingerprint sensor 1611, the input sensor 1612, and the digitizer 1613 may be formed to be integrated into one sensing panel via the same process. The sensing panel may be disposed between the display panel 1410 and a window placed on an upper side of the display panel 1410, but embodiments are not limited thereto.

In addition, the sensor module 1610 may generate an electric signal or data value corresponding to an internal status or external status of the electronic device 1000. The sensor module 1610 may include, for example, a proximity sensor, an illumination sensor, an acceleration sensor, a magnetic sensor, a gravity (G)-sensor, a gyroscope sensor, a motion sensor, an RGB sensor, an infrared (IR) sensor, a finger scan sensor, an ultrasonic sensor, an optical sensor, a battery gauge, an environment sensor (e.g., a barometer, a hygrometer, a thermometer, a radiation sensor, a heat sensor, and a gas sensor), and a chemical sensor (e.g., an electronic nose, a healthcare sensor, and a biometric sensor).

The antenna module 1620 may include one or more antennas for transmitting signals or power to the outside or receiving signals or power from the outside. According to an embodiment, the communication module 1730 may transmit a signal to an external electronic device or receive a signal from the external electronic device, through an antenna suitable for a communication method. An antenna pattern of the antenna module 1620 may be integrated into one component of the display module 1400 (e.g., the display panel 1410) or into the input sensor 1612, for example.

The audio output module 1630, which is a device for outputting an audio signal to the outside of the electronic device 1000, may output audio data received from the communication module 1730 in a call signal reception mode, a call or recording mode, a voice recognition mode, a broadcast reception mode, etc. or stored in the memory 1200. The audio output module 1630 may output an audio signal related with a function (for example, a call signal receiving sound or a message receiving sound) performed by the electronic device 1000. The audio output module 1630 may include a receiver and a speaker. A least one selected from the receiver and the speaker may be an audio generation device that is attached to a lower portion of the display panel 1410 and vibrates the display panel 1410 to output an audio. The audio generation device may be a piezoelectric element or piezoelectric actuator that shrinks and expands in response to an electrical signal, or may be an exciter that generates a magnetic force by using a voice coil and vibrates the display panel 1410.

The camera module 1710 may capture a still image and a video. According to an embodiment, the camera module 1710 may include one or more lenses, an image sensor, or an image signal processor. The camera module 1710 may further include an infrared camera capable of measuring presence or absence of a user, the user's location, the user's view, etc.

The light module 1720 may output a signal for notifying occurrence of an event by using light from a light source, or may provide light for image obtainment. Examples of the event occurrence may include message reception, call signal reception, a missed call, an alarm, schedule notification, e-mail reception, and notification of battery charging capacity information. The light module 1720 may include a light-emitting diode or a xenon lamp. The light module 1720 may emit light of a single color or light beams of a plurality of colors to a front surface or rear surface of the electronic device 1000. The light module 1720 may operate in conjunction with the camera module 1710 or may operate independently.

The communication module 1730 may support establishment of a wired or wireless communication channel between the electronic device 1000 and the external electronic device 2000, and execution of communication through an established communication channel. The communication module 1730 may include one or both of a wireless communication module (such as, a cellular communication module, a short-range wireless communication module, or a global navigation satellite system (GNSS) communication module) and a wired communication module (such as, a local area network (LAN) communication module or a power line communication module). The communication module 1730 may transmit and receive a wireless signal on the Internet by using at least one selected from Wireless LAN (WLAN), Wireless-Fidelity (Wi-Fi), Wi-Fi Direct, and Digital Living Network Alliance (DLNA) technologies. The communication module 1730 may support short-distance communication by using at least one technology from among Bluetooth™, Radio Frequency Identification (RFID), Infrared Data Association (IrDA), Ultra Wideband (UWB), ZigBee, Near Field Communication (NFC), Wi-Fi, Wi-Fi Direct, and Wireless Universal Serial Bus (Wireless USB). The aforementioned various types of communication modules 1730 may be implemented as one chip or as separate chips.

The electronic device 1000 may output various pieces of information through the display module 1400 within an operating system. When the processor 1100 executes an application stored in the memory 1200, the display module 1400 provides application information to the user through the display panel 1410.

The processor 1100 outputs a command or data to the display module 1400, the audio output module 1630, the camera module 1710, or the light module 1720, based on input data received from the input module 1300 or the sensor module 1610. In an embodiment, for example, the processor 1100 may generate image data corresponding to the input data and output the image data to the display module 1400, or may generate command data corresponding to the input data and output the command data to the camera module 1710 or the light module 1720. When no input data is received from the input module 1300 for a certain period of time, the processor 1100 may switch an operation mode of the electronic device 1000 to a low power mode or sleep mode to thereby reduce power consumed by the electronic device 1000.

The processor 1100 obtains an external input through the input module 1300 or the sensor module 1610, and execute an application corresponding to the external input. For example, when the user selects a camera icon displayed on the display panel 1410, the processor 1100 obtains a user input through the input sensor 1612 and activates the camera module 1710. The processor 1100 transmits image data corresponding to a captured image obtained through the camera module 1710 to the display module 1400. The display module 1400 may display an image corresponding to the captured image through the display panel 1410.

For example, when personal information authentication is performed in the display module 1400, the fingerprint sensor 1611 obtains input fingerprint information as the input data. The processor 1100 compares the input data obtained through the fingerprint sensor 1611 with authentication data stored in the memory 1200, and executes an application based on a result of the comparison. The display module 1400 may display, through the display panel 1410, information executed according to the application's logic.

For example, when a music streaming icon displayed on the display module 1400 is selected, the processor 1100 obtains a user input through the input sensor 1612 and activates a music streaming application stored in the memory 1200. When a music execution command is input in the music streaming application, the processor 1100 activates the audio output module 1630 to provide the user with audio information conforming to the music execution command.

Some of the aforementioned components may be connected to each other via a communication method between peripheral apparatuses, such as a bus, a general-purpose input/output (GPIO), a serial peripheral interface (SPI), a mobile industry processor interface (MIPI), or an ultra-path interconnect (UPI) link, to exchange signals (e.g., commands or data) with each other. According to an embodiment, the main processor 1110 may transmit an image signal to the auxiliary processor 1120 via an MIPI.

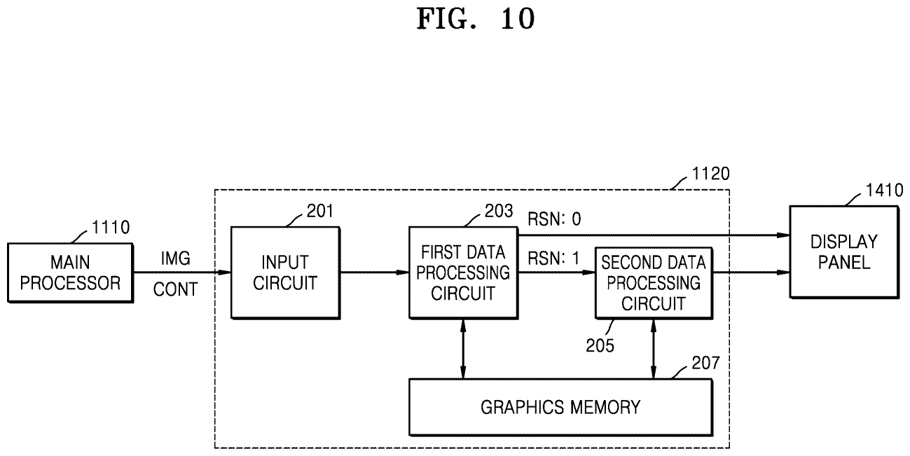

FIG. 10 is a block diagram for explaining the auxiliary processor 1120 according to an embodiment.

Referring to FIGS. 9 and 10, an embodiment of the electronic device 1000 may include the main processor 1110, the auxiliary processor 1120, and the display panel 1410. The auxiliary processor 1120 may be included as a Timing Controller (T-con) Embedded Driver Integrated Circuit (IC) in which the controller 1121 and data processing circuits are integrated.

The main processor 1110 may be an application processor. The main processor 1110 may include the GPU 1112. According to an embodiment, the main processor 1110 may transmit an image signal IMG and a control signal CONT to the auxiliary processor 1120.

The auxiliary processor 1120 may include an input circuit 201, a first data processing circuit 203, a second data processing circuit 205, and a graphics memory 207. The input circuit 201 may include a receiver that receives the image signal IMG from the main processor 1110, and a decoder that converts a data format of the image signal IMG to generate image data. The input circuit 201 may output various control signals necessary for driving the display module 1400, based on the control signal CONT received from the main processor 1110.

The auxiliary processor 1120 may further include a register memory. The auxiliary processor 1120 may output the image data by using only the first data processing circuit 203 or by using both the first data processing circuit 203 and the second data processing circuit 205, according to a register signal RSN pre-stored in the register memory. For example, when the register signal RSN has a value of 0, the second data processing circuit 205 may be turned off, so that the image data may be converted by the first data processing circuit 203 and transmitted to the display panel 1410. When the register signal RSN has a value of 1, the second data processing circuit 205 may be turned on, so that the image data may be converted by the first data processing circuit 203 and the second data processing circuit 205 and transmitted to the display panel 1410.

The value of the register signal RSN may be stored as 1 when the electronic device 1000 includes the display module 1400 to which an alternative data driving (ADD) technology for driving a pair of data lines connected to the same output line in a time-multiplexing manner is applied, and may be stored as 0 when the electronic device 1000 includes the display module 1400 to which the ADD technology is not applied. Therefore, the auxiliary processor 1120 according to an embodiment may be used in both the display module 1400 to which the ADD technology is applied and the display module 1400 to which the ADD technology is not applied. The register signal RSN may be stored in the memory 1200 during a manufacturing process of the electronic device 1000.

The first data processing circuit 203 may receive the image data from the input circuit 201, sequentially store the image data in the graphics memory 207, and convert the image data according to the characteristics of the display module 1400 or the user's settings. The first data processing circuit 203 may include at least one of the data conversion circuit 1122, the gamma correction circuit 1123, and the rendering circuit 1124. The first data processing circuit 203 may convert image data and store a result of the conversion in the graphics memory 207, based on the order in which the image data is input, sequentially read the image data stored in the graphics memory 207, and output the sequentially-read image data to the display panel 1410.

The second data processing circuit 205 may read the image data stored in the graphics memory 207 and output the read-out image data to the display panel 1410, according to the order in which pixels are driven. In other words, the second data processing circuit 205 may remap the image data and output the remapped image data to the display panel 1410, based on the order in which pixels are driven.

According to an embodiment, the display module 1400 may drive pixels connected to the first gate line GWL1 of FIGS. 4A and 6A among the pixels during the first sub-frame period 1SF of FIGS. 4B and 6B, and may drive pixels connected to the second gate line GWL2 of FIGS. 4A and 6A among the pixels during the second sub-frame period 2SF of FIGS. 4B and 6B. The image data may include pieces of sub-data corresponding to the pixels, respectively. In the image data stored in the graphics memory 207 by the first data processing circuit 203 based on the order in which the image data is input, pieces of sub-data corresponding to pixels connected to the first gate lines GWL1 and pieces of sub-data corresponding to pixels connected to the second gate lines GWL2 may be arranged based on an arrangement of pixels.

The second data processing circuit 205 may remap pieces of sub-data, based on the arrangement of pixels and the order in which pixels are driven. That is, the second data processing circuit 205 may first read pieces of sub-data corresponding to pixels driven during the first sub-frame period 1SF and output them to the display panel 1410 during the first sub-frame period 1SF, and then read pieces of sub-data corresponding to pixels driven during the second sub-frame period 2SF and output them to the display panel 1410 during the second sub-frame period 2SF. The pixels driven during the first sub-frame period 1SF may be connected to the first gate lines GWL1, and the pixels driven during the second sub-frame period 2SF may be connected to the second gate lines GWL2.

The auxiliary processor 1120 may include an output circuit that receives pieces of sub-data, converts them into a data voltage in the form of an analog voltage, and then outputs the data voltage to its corresponding output line OL of FIGS. 4A and 6A. The first data processing circuit 203 or the second data processing circuit 205 may transmit pieces of sub-data to the display panel 1410 through the output circuit.

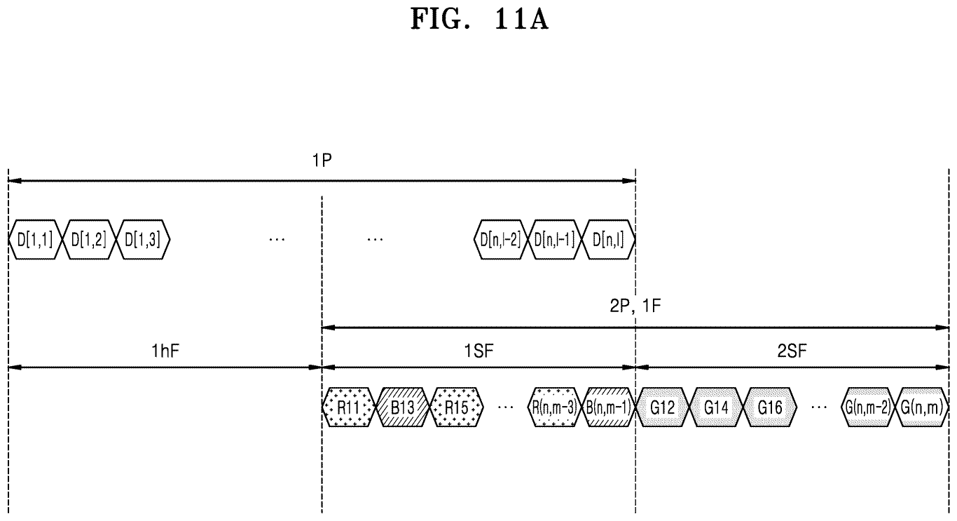

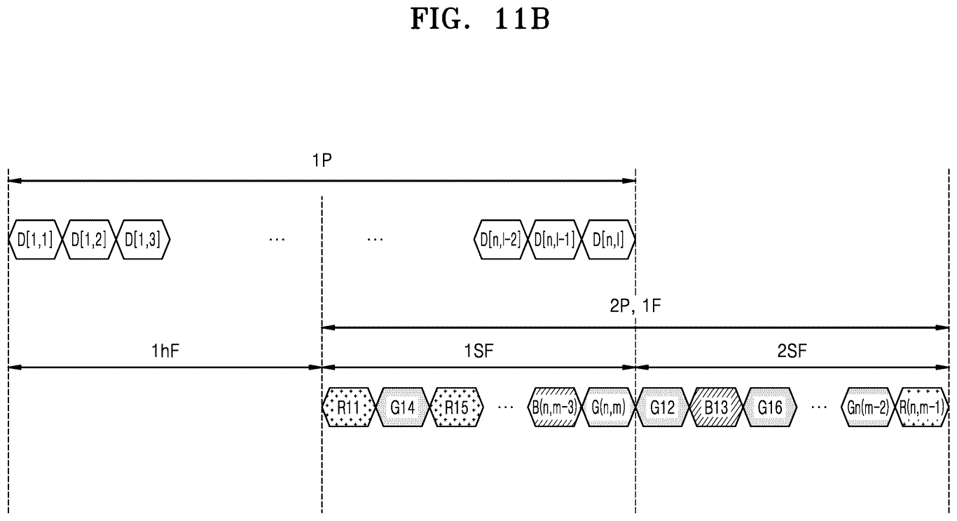

FIGS. 11A and 11B are diagrams for schematically explaining an operation of an auxiliary processor according to an embodiment.

Referring to FIGS. 10, 11A, and 11B, in an embodiment, the display panel 1410 may include a plurality of pixels arranged in an n×m matrix form. Here, n and m are natural numbers equal to or greater than 1. The plurality of pixels may include first pixels that emit light in a first color, second pixels that emit light in a second color, and third pixels that emit light in a third color. In odd-numbered columns of the pixel matrix, the first pixels and the second pixels may be arranged alternately in a column direction, and, in even-numbered columns of the pixel matrix, the second pixels may be arranged repeatedly. Two pixels adjacent to each other and arranged in a same row may be defined as one pixel pair. The two pixels included in one pixel pair may be respectively connected to two data lines DL connected to a same output line OL of FIG. 4A.

A first period 1P may be a writing period in which the first data processing circuit 203 writes image data to the graphics memory 207. During the first period 1P, the first data processing circuit 203 may receive the image data from the input circuit 201 and store the image data in the graphics memory 207 in the order in which the image data is input. The first data processing circuit 203 may compensate for the image data, or may convert a gamma reference voltage according to the characteristics of the display panel 1410 or the user's settings. The first data processing circuit 203 may render the image data by taking into account a pixel layout of the display panel 1410. In an embodiment, for example, the image data may be arranged in units of pixel pairs. The first data processing circuit 203 may sequentially store n×l pieces of pixel pair data, from [1,1]th pixel pair data D[1,1] to [n, l]th pixel pair data D[n, l] located in an n-th row and an l-th column, in the graphics memory 207. Here, l is m/2 and may be equal to the number of output lines OL connected to the data driver 1430 of FIG. 9. One piece of pixel pair data may include two pieces of sub-data. Each sub-data corresponds to one pixel. [1,1]th pixel pair data D[1,1]) may include sub-data of a pixel arranged in a first row and a first column and sub-data of a pixel arranged in the first row and a second column, and [n, l]th pixel pair data D[n, l] may include sub-data of a pixel arranged in an n-th row and an (m-1)-th column and sub-data of a pixel arranged in the n-th row and an m-th column.

A second period 2P may be a period in which the second data processing circuit 205 reads pieces of sub-data from the graphics memory 207, outputs the pieces of sub-data to the display panel 1410, and writes data voltages to the display panel 1410. The second period 2P may be substantially the same period as one frame 1F of the display panel 1410. The second period 2P may include a first sub-frame period 1SF and a second sub-frame period 2SF.

The first sub-frame period 1SF may be a period for reading pieces of sub-data corresponding to pixels connected to the first gate lines GWL1 in units of rows, outputting the pieces of sub-data to the display panel 1410, and writing data voltages to the pixels connected to the first gate lines GWL1. The second sub-frame period 2SF may be a period for reading pieces of sub-data corresponding to pixels connected to the second gate lines GWL2 in units of rows, outputting the pieces of sub-data to the display panel 1410, and writing data voltages to the pixels connected to the second gate lines GWL2. In order to read all pieces of sub-data corresponding to pixels connected to the first gate lines GWL1 during the first sub-frame period 1SF, a start timing of the second period 2P may be delayed by a half frame 1hF from the start timing of the first period 1P. Each of the first sub-frame period 1SF and the second sub-frame period 2SF may have the same length as the half frame 1hF.

According to an embodiment, as shown in FIG. 4A, pixels arranged in an odd-numbered column among the pixels may be connected to the first gate lines GWL1, and pixels arranged in an even-numbered column among the pixels may be connected to the second gate lines GWL2. That is, the first color pixels and the second color pixels arranged in the odd-numbered column may be driven during the first sub-frame period 1SF, and the third color pixels arranged in the even-numbered column may be driven during the second sub-frame period 2SF. Pieces of pixel pair data D[1,1], D[1,2], . . . , D[n, l-1], and D[n, l] may have a layout corresponding to an arrangement of pixels. Pieces of odd-numbered sub-data of the pieces of pixel pair data D[1,1], D[1,2], . . . , D[n, l-1], and D[n, l] may correspond to pixels driven during the first sub-frame period 1SF, and pieces of even-numbered sub-data thereof may correspond to pixels driven during the second sub-frame period 2SF.

The second data processing circuit 205 may read the pieces of sub-data from the pieces of pixel pair data D[1,1], D[1,2], . . . , D[n, l-1], and D[n, l] stored in the graphics memory 207 during the first sub-frame period 1SF in the order of R11, B13, R15, B17, . . . , B(n, m-3), and R(n, m-1), and output them to the display panel 1410. The second data processing circuit 205 may read the pieces of sub-data from the pieces of pixel pair data D[1,1], D[1,2], . . . , D[n, l-1], and D[n, l] stored in the graphics memory 207 during the second sub-frame period 2SF in the order of G12, G14, G16, . . . , G(n, m-2), G(n, m), and output them to the display panel 1410.

According to another embodiment, as illustrated in FIG. 6A, pixels belonging to an odd-numbered pixel pair and arranged in an odd-numbered column and pixels belonging to an even-numbered pixel pair and arranged in an even-numbered column may be connected to the first gate lines GWL1, and pixels belonging to an odd-numbered pixel pair and arranged in an even-numbered column and pixels belonging to an even-numbered pixel pair and arranged in an odd-numbered column may be connected to the second gate lines GWL2. In other words, the pixels belonging to the odd-numbered pixel pair and arranged in the odd-numbered column and the pixels belonging to the even-numbered pixel pair and arranged in the even-numbered column may be driven during the first sub-frame period 1SF, and the pixels belonging to the odd-numbered pixel pair and arranged in the even-numbered column and the pixels belonging to the even-numbered pixel pair and arranged in the odd-numbered column may be driven during the second sub-frame period 2SF.

Pieces of odd-numbered sub-data of pieces of odd-numbered pixel pair data among the pieces of pixel pair data D[1,1], D[1,2], . . . , D[n, l-1], and D[n, l], and pieces of even-numbered sub-data of pieces of even-numbered pixel pair data thereamong may correspond to the pixels driven during the first sub-frame period 1SF. Pieces of even-numbered sub-data of the pieces of odd-numbered pixel pair data among the pieces of pixel pair data D[1,1], D[1,2], . . . , D[n, l-1], and D[n, l], and pieces of odd-numbered sub-data of the pieces of even-numbered pixel pair data thereamong may correspond to the pixels driven during the second sub-frame period 2SF.

The second data processing circuit 205 may read the pieces of sub-data from the pieces of pixel pair data D[1,1], D[1,2], . . . , D[n, l-1], and D[n, l] stored in the graphics memory 207 during the first sub-frame period 1SF in the order of R11, G14, R15, G18, . . . , B(n, m-3), and G(n, m), and output them to the display panel 1410. The second data processing circuit 205 may read the pieces of sub-data from the pieces of pixel pair data D[1,1], D[1,2], . . . , D[n, l-1], and D[n, l] stored in the graphics memory 207 during the second sub-frame period 2SF in the order of G12, B13, G16, B17, . . . , G(n, m-2), and R(n, m-1), and output them to the display panel 1410.

In an embodiment where the display module 1400 is a display module to which ADD technology is not applied, the value of the register signal RSN of the auxiliary processor 1120 may be 0, and the second data processing circuit 205 may be in an off state. The image data may be converted by the first data processing circuit 203 and output to the display panel 1410. The first data processing circuit 203 may sequentially output the pieces of pixel pair data D[1,1], D[1,2], . . . , D[n, l-1], and D[n, l] to the display panel 1410.

The auxiliary processor 1120 according to an embodiment may turn on or off the second data processing circuit 205 based on the value of the register signal RSN, and thus the auxiliary processor may be used in both the display module 1400 to which the ADD technology is applied and the display module to which the ADD technology is not applied. The electronic device 1000 including the display module 1400 to which the ADD technology is applied may time-multiplex a period in which a first color data voltage and a second color data voltage are output and a period in which a third color data voltage is output, through one output line, leading to an improvement in power consumption due to data voltage toggling.

According to an embodiment as described above, a processor with reduced manufacturing costs due to a reduction in the number of output lines, a display device including the processor, and an electronic device including the processor may be implemented. According to an embodiment, a processor with reduced power consumption, a display device including the processor, and an electronic device including the processor may be implemented.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a pixel unit including pixels connected to data lines, gate lines, and light-emission control lines;
a data driver which outputs a data voltage through output lines;
a data distribution circuit which connects each of the output lines to one of a pair of data lines in response to a first control signal during a first sub-frame period and connects each of the output lines to the other of the pair of data lines in response to a second control signal during a second sub-frame period;
a first gate driver which sequentially outputs a first gate signal to each of first gate lines among the gate lines during the first sub-frame period;
a second gate driver which sequentially outputs a second gate signal to each of second gate lines among the gate lines during the second sub-frame period; and
a light-emission control driver which divides the light-emission control lines into groups of four and outputs light-emission control signals in units of groups.

2. The display device of claim 1, wherein the data distribution circuit connects each of the output lines to an odd-numbered data line among the pair of data lines during the first sub-frame period and connects each of the output lines to an even-numbered data line among the pair of data lines during the second sub-frame period.

3. The display device of claim 2, wherein
pixels connected to the odd-numbered data lines are respectively connected to the first gate lines, and
pixels connected to the even-numbered data lines are respectively connected to the second gate lines.

4. The display device of claim 1, wherein
the data distribution circuit connects each of odd-numbered output lines among the output lines to an odd-numbered data line among the pair of data lines and connects each of even-numbered output lines from among the output lines to an even-numbered data line from among the pair of data lines during the first sub-frame period, and
the data distribution circuit connects each of the odd-numbered output lines from among the output lines to the even-numbered data line among the pair of data lines and connects each of the even-numbered output lines among the output lines to the odd-numbered data line from among the pair of data lines during the second sub-frame period.

5. The display device of claim 1, wherein
the pixel unit includes first pixels and second pixels, which are respectively connected to an odd-numbered data lines among the pair of data lines and alternately arranged in a column direction, and third pixels respectively connected to an even-numbered data lines among the pair of data lines and repeatedly arranged in the column direction, and
the first pixels, the second pixels and the third pixels emit light of different colors, respectively.

6. The display device of claim 5, wherein the data driver alternately outputs a first data voltage and a second data voltage to each of the output lines in synchronization with an output timing of the first gate signal during the first sub-frame period, and outputs a third data voltage to each of the output lines in synchronization with an output timing of the second gate signal during the second sub-frame period.

7. The display device of claim 5, wherein
the data driver alternately outputs a first color data voltage and a second color data voltage to each of odd-numbered output lines among the output lines in synchronization with an output timing of the first gate signal and outputs a third color data voltage to each of even-numbered output lines among the output lines in synchronization with an output timing of the first gate signal during the first sub-frame period, and
the data driver outputs the third color data voltage to each of the odd-numbered output lines among the output lines in synchronization with the output timing of the second gate signal and alternately outputs the first color data voltage and the second color data voltage to each of the even-numbered output lines among the output lines in synchronization with the output timing of the second gate signal during the second sub-frame period.

8. The display device of claim 1, wherein
the first gate driver sequentially outputs the first gate signal to each of the first gate lines in synchronization with an output timing of the first control signal during the first sub-frame period, and
the second gate driver sequentially outputs the second gate signal to each of the second gate lines in synchronization with an output timing of the second control signal during the second sub-frame period.

9. The display device of claim 1, wherein the light-emission control driver outputs the light-emission control signals in synchronization with an output timing of a first light-emission control clock signal and an output timing of a second light-emission control clock signal delayed at a preset interval from the first light-emission control clock signal,
an odd-numbered light-emission control signal among the light-emission control signals is output in synchronization with the output timing of the first light-emission control clock signal, and
an even-numbered light-emission control signal among the light-emission control signals is output in synchronization with the output timing of the second light-emission control clock signal.

10. The display device of claim 1, wherein the light-emission control driver operates once during the first sub-frame period and operate once during the second sub-frame period,
the light-emission control driver includes light-emission control stages connected to each other in a dependent manner, and
each of the light-emission control stages is connected to a corresponding group of four light-emission control lines from among the light-emission control lines to simultaneously supply a corresponding light-emission control signal among the light-emission control signals thereto.

11. A processor comprising:
a graphics memory;
an input circuit which receives an image signal and converts the image signal to generate image data;
a first data processing circuit which stores the image data in the graphics memory according to an inputting order; and
a second data processing circuit which reads pieces of sub-data corresponding to pixels driven during a first sub-frame period from the image data stored in the graphics memory and outputs the read-out pieces of sub-data to an output channel, and reads pieces of sub-data corresponding to pixels driven during a second sub-frame period and outputs the read-out pieces of sub-data to the output channel.

12. The processor of claim 11, wherein
the first data processing circuit stores the image data in the graphics memory during a first period,
the second data processing circuit reads the pieces of sub-data and output the read-out pieces of sub-data to the output channel during a second period, and
a portion of the first period overlaps the second period.

13. The processor of claim 12, wherein a start timing of the second period is delayed by half a frame from a start timing of the first period.

14. The processor of claim 11, wherein
the image data includes pieces of pixel pair data including two pieces of sub-data,
the second data processing circuit reads pieces of odd-numbered sub-data from the pieces of pixel pair data and outputs the read-out pieces of odd-numbered sub-data to the output channel during the first sub-frame period, and
the second data processing circuit reads pieces of even-numbered sub-data from the pieces of pixel pair data and outputs the read-out pieces of even-numbered sub-data to the output channel during the second sub-frame period.

15. The processor of claim 11, wherein
the image data includes pieces of pixel pair data including two pieces of sub-data,
the second data processing circuit reads pieces of odd-numbered sub-data from odd-numbered pieces of pixel pair data among the pieces of pixel pair data, reads pieces of even-numbered sub-data from even-numbered pieces of pixel pair data among the pieces of pixel pair data and outputs the read-out pieces of even-numbered sub-data to the output channel during the first sub-frame period, and
the second data processing circuit reads pieces of even-numbered sub-data from the odd-numbered pieces of pixel pair data among the pieces of pixel pair data, reads pieces of odd-numbered sub-data from the even-numbered pieces of pixel pair data among the pieces of pixel pair data and outputs the read-out pieces of odd-numbered sub-data to the output channel during the second sub-frame period.

16. An electronic device comprising:
a display module; and
a processor which controls the display module,
wherein the processor comprises:
a graphics memory;
an input circuit which receives an image signal and converts the image signal to generate image data;
a first data processing circuit which stores the image data in the graphics memory according to an inputting order; and
a second data processing circuit which reads pieces of sub-data corresponding to pixels driven during a first sub-frame period from the image data stored in the graphics memory and outputs the read-out pieces of sub-data to an output channel, and reads pieces of sub-data corresponding to pixels driven during a second sub-frame period and outputs the read-out pieces of sub-data to the output channel.

17. The electronic device of claim 16, wherein the display module comprises:
a pixel unit including pixels connected to data lines, gate lines, and light-emission control lines;
a data driver which outputs a data voltage through output lines;
output lines connected to the data driver;
a data distribution circuit which connects each of the output lines to one of a pair of data lines in response to a first control signal during a first sub-frame period and connects each of the output lines to the other of the pair of data lines in response to a second control signal during a second sub-frame period;
a first gate driver which sequentially outputs a first gate signal to each of first gate lines among the gate lines during the first sub-frame period; and
a second gate driver which sequentially outputs a second gate signal to each of second gate lines among the gate lines during the second sub-frame period.

18. The electronic device of claim 17, wherein the display module further comprises a light-emission control driver which divides the light-emission control lines into groups of four and outputs light-emission control signals in units of groups.

19. The electronic device of claim 17, wherein the data distribution circuit connects each of the output lines to an odd-numbered data line among the pair of data lines during the first sub-frame period and connects each of the output lines to an even-numbered data line among the pair of data lines during the second sub-frame period, 20. The electronic device of claim 17, wherein
the data distribution circuit connects each of odd-numbered output lines among the output lines to an odd-numbered data line among the pair of data lines and connects each of even-numbered output lines among the output lines to an even-numbered data line among the pair of data lines during the first sub-frame period, and
the data distribution circuit connects each of the odd-numbered output lines among the output lines to the even-numbered data line among the pair of data lines and connects each of the even-numbered output lines among the output lines to the odd-numbered data line among the pair of data lines during the second sub-frame period.
